(19) United States
(12) Patent Application Publication
(10) Pub. No.: US 2023/0266638 A1
(43) Pub. Date: Aug. 24, 2023

(54) CAMERA MODULE

(71) Applicant: Samsung Electro-Mechanics Co., Ltd., Suwon-si (KR)

(72) Inventors: Nam Ju LEE, Suwon-si (KR); Min Jeong KANG, Suwon-si (KR); Young Bok YOON, Suwon-si (KR); Bo Sung SEO, Suwon-si (KR)

(73) Assignee: Samsung Electro-Mechanics Co., Ltd., Suwon-si (KR)

(21) Appl. No.: 18/112,110

(22) Filed: Feb. 21, 2023

(30) Foreign Application Priority Data
Feb. 22, 2022 (KR) 10-2022-0023182
Dec. 15, 2022 (KR) 10-2022-0175882

(51) Int. Cl. G03B 13/36; H02K 41/035

(52) U.S. Cl. CPC G03B 13/36; H02K 41/0354

(57) ABSTRACT

A camera module includes a housing having an internal space; a carrier disposed in the internal space of the housing; a lens module disposed in the carrier; a first driver including a first magnet coupled to the carrier, and a first coil facing the first magnet; and a first ball unit and a second ball unit disposed between the carrier and the housing and spaced apart from each other in a direction perpendicular to an optical axis of the camera module, wherein the first ball unit includes two or more balls disposed in an optical axis direction, and the second ball unit includes a smaller number of balls than the first ball unit disposed in the optical axis direction, and a distance between the first ball unit and the second ball unit is greater than a length of a longest side of the carrier.

### CROSS-REFERENCE TO RELATED APPLICATIONS

This application claims the benefit under 35 USC 119(a) of Korean Patent Application Nos. 10-2022-0023182 filed on Feb. 22, 2022, and 10-2022-0175882 filed on Dec. 15, 2022, in the Korean Intellectual Property Office, the entire disclosures of which are incorporated herein by reference for all purposes.

### SUMMARY

### 1. Field

The present disclosure relates to a camera module.

### 2. Description of Related Art

Recently, camera modules have been employed in mobile communication terminals such as smartphones, tablet PCs, and laptops.

In addition, the camera module may be provided with an actuator having an autofocus function to generate a high-resolution image.

For example, an actuator driving the autofocus function may include a magnet and a coil generating a driving force, and may further include a plurality of balls supporting the movement of a lens module in an optical axis direction.

In order to improve an autofocus performance, the lens module has to move in a direction parallel to the optical axis direction without tilting.

However, when the movement of the lens module in the optical axis direction is supported by a plurality of balls, the lens module may tilt when moving.

That is, there may be a problem in which the lens module may tilt during autofocusing, thereby adversely affecting the autofocusing performance.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing having an internal space; a carrier disposed in the internal space of the housing; a lens module disposed in the carrier; a first driver including a first magnet coupled to the carrier, and a first coil facing the first magnet; and a first ball unit and a second ball unit disposed between the carrier and the housing and spaced apart from each other in a direction perpendicular to an optical axis of the camera module, wherein the first ball unit includes two or more balls disposed in an optical axis direction, the second ball unit includes a smaller number of balls than the first ball unit disposed in the optical axis direction, and a distance between the first ball unit and the second ball unit is greater than a length of a longest side of the carrier.

When viewed in the optical axis direction, a virtual line connecting a center of a ball of the first ball unit and a center of a ball of the second ball unit may pass through the lens module.

When viewed in the optical axis direction, a virtual line connecting a center of a ball of the first ball unit and a center of a ball of the second ball unit may form an acute angle with respect to a line extending from one surface of the first magnet in a longitudinal direction of the first magnet.

When viewed in the optical axis direction, a virtual line extending from one surface of the first magnet in contact with the carrier in a longitudinal direction of the first magnet may pass through the first ball unit and be spaced apart from the second ball unit.

The camera module may further include an image sensor module coupled to the housing and including an image sensor, wherein when viewed in the optical axis direction, a center of the image sensor may be disposed in a region defined by lines connecting opposite sides of the first ball unit to opposite side of the second ball unit.

A first set of guide grooves and a second set of guide grooves may be formed in the carrier and the housing, the first set of guide grooves may include a first guide groove formed in the carrier and a second guide groove formed in the housing, the second set of guide grooves may include a third guide groove formed in the carrier and a fourth guide groove formed in the housing, the first ball unit may be disposed between the first guide groove and the second guide groove, the second ball unit may be disposed between the third guide groove and the fourth guide groove, and a direction in which a center of the first guide groove faces a center of the second guide groove may be different from a direction in which a center of the third guide groove faces a center of the fourth guide groove.

The first ball unit may contact the first guide groove at a first contact point and a second contact point, and may contact the second guide groove at a third contact point and a fourth contact point, the first contact point and the third contact point may face each other in a first direction perpendicular to the optical axis direction, and the second contact point and the fourth contact point may face each other in a second direction perpendicular to both the optical axis direction and the first direction.

The first magnet may be closer to the first ball unit than to the second ball unit.

The camera module may further include a guide frame disposed between the lens module and the carrier; a third ball unit disposed between the carrier and the guide frame; and a fourth ball unit disposed between the lens module and the guide frame.

A third set of guide grooves in which the third ball unit is disposed may be formed in a lower surface of the guide frame facing the carrier in the optical axis direction, a fourth set of guide grooves in which the fourth ball unit is disposed may be formed in an upper surface of the guide frame facing the lens module in the optical axis direction, and the third set of guide grooves and the fourth set of guide grooves may not overlap each other when viewed in the optical axis direction.

The third set of guide grooves and the fourth set of guide grooves may not overlap each other in a first direction perpendicular to the optical axis direction, some grooves of the third set of guide grooves and some grooves of the fourth set of guide grooves may overlap each other in a second direction perpendicular to both the optical axis direction and the first direction, and other grooves of the third set of guide grooves and other grooves of the fourth set of guide grooves may not overlap each other in the second direction.

The camera module may further include a second driver including a second magnet coupled to the lens module, and a second coil facing the second magnet, and a third driver including a third magnet coupled to the lens module, and a third coil facing the third magnet, wherein each of the second magnet and the third magnet may closer to the second ball unit than to the first ball unit.

The camera module may further include a substrate mounted on the housing and on which the first to third coils are mounted, wherein the first ball unit may be disposed at one corner of the housing, the second ball unit may be disposed at another corner of the housing diagonally opposite from the one corner of the housing, and the substrate may surround the other corner of the housing.

In another general aspect, a camera module includes a housing having an internal space; a carrier disposed in the internal space of the housing; a lens barrel disposed in the carrier; a first driver including a first magnet coupled to the carrier, and a first coil facing the first magnet; a first yoke fixed to the housing; and a first ball unit and a second ball unit disposed between the carrier and the housing and spaced apart from each other in a direction perpendicular to an optical axis direction of the camera module, wherein the first ball unit includes two or more balls disposed in the optical axis direction, the second ball unit includes a smaller number of balls than the first ball unit disposed in the optical axis direction, and when viewed in the optical axis direction, a length of a virtual line connecting a center of the first ball unit and a center of the second ball unit is greater than a maximum diameter of the lens barrel.

The first magnet may include a first sub-magnet disposed on one side of the carrier, and a second sub-magnet disposed on another side of the carrier on an opposite side of the carrier from the one side of the carrier, the first coil may include a first sub-coil facing the first sub-magnet, and a second sub-coil facing the second sub-magnet, and the first yoke may include a first sub-yoke facing the first sub-magnet, and a second sub-yoke facing the second sub-magnet.

When viewed in the optical axis direction, a virtual line connecting a center of the first ball unit and a center of the second ball unit may form an acute angle with respect to the one side of the carrier on which the first sub-magnet is disposed, and with respect to the other side of the carrier on which the second sub-magnet is disposed.

A center of the first sub-magnet may be offset toward the first ball unit from a the center of the one side of the carrier, and a center of the second sub-magnet may be offset toward the second ball unit from a center of the other side of the carrier.

The camera module may further include an image sensor module coupled to the housing and including an image sensor, wherein when viewed in the optical axis direction, a center of the image sensor may be disposed in a region in which a first region defined by lines connecting opposite sides of the first ball unit to opposite sides of the second ball unit may overlap a second region defined by lines connecting opposite ends of the first sub-magnet to opposite ends of the second sub-magnet.

The carrier may include a first guide groove and a third guide groove, and the housing may include a second guide groove and a fourth guide groove, the first ball unit may be disposed between the first guide groove and the second guide groove, the second ball unit may be disposed between the third guide groove and the fourth guide groove, the first ball unit may contact the first guide groove at a first contact point and a second contact point, the first ball unit may contact the second guide groove at a third contact point and a fourth contact point, the first contact point and the third contact point may face each other in a first direction perpendicular to the optical axis direction, and the second contact point and the fourth contact point may face each other in a second direction perpendicular to both the optical axis direction and the first direction.

In another general aspect, a camera module includes a housing having an internal space and four corners when viewed in an optical axis direction of the housing; a carrier disposed in the internal space of the housing; a lens module disposed in the carrier; a first driver configured to move the carrier and the lens module together in the optical axis direction; a first ball unit extending in the optical axis direction and disposed between the carrier and the housing at a first corner of the housing; and a second ball unit extending in the optical axis direction and disposed between the carrier and the housing at a second corner of the housing diagonally opposite from the first corner of the housing, wherein the first ball unit and the second ball unit are the only ball units disposed between the carrier and the housing, and support the carrier in the housing to enable the carrier and the lens module to be moved together in the optical axis direction by the first driver.

The first ball unit may include two or more balls disposed in the optical axis direction, and the second ball unit may include a smaller number of balls than the first ball unit disposed in the optical axis direction.

The first driver may include a first magnet disposed on one side of the carrier, and a first coil fixed to the housing and facing the first magnet in a first direction perpendicular to the optical axis direction, the camera module further may include a first yoke fixed to the housing and facing the first magnet in the first direction with the first coil being disposed between the first yoke and the first magnet, and an attractive force generated between the first magnet and the first yoke in the first direction may apply a rotational force to the carrier in a plane perpendicular to the optical axis direction.

A center of the first magnet may be offset in a second direction perpendicular to both the optical axis direction and the first direction from a center of the one side of the carrier on which the first magnet is disposed.

In another general aspect, a camera module includes a housing having an internal space; a carrier disposed in the internal space of the housing; a lens module disposed in the carrier; a first driver configured to move the carrier and the lens module together in an optical axis direction of the camera module while applying a rotational force to the carrier in a plane perpendicular to the optical axis; a first ball unit extending in the optical axis direction and disposed between the carrier and the housing; and a second ball unit extending in the optical axis direction and disposed between the carrier and the housing, wherein the first ball unit and the second ball unit support the carrier in the housing to enable the carrier and the lens module to be moved together in the optical axis direction by the first driver.

The driver may include a first sub-magnet disposed on one side of the carrier; a first sub-coil fixed to the housing and facing the first sub-magnet in a first direction perpendicular to the optical axis direction; a second sub-magnet disposed on another side of the carrier on an opposite side of the carrier from the one side of the carrier in the first direction; and a second sub-coil fixed to the housing and facing the second sub-magnet in the first direction, the one side of the carrier on which the first sub-magnet is disposed and the other side of the carrier on which the second sub-magnet is disposed may extend in a second direction perpendicular to both the optical axis direction and the first direction, and when viewed in the optical axis direction, a virtual line extending through a center of the first sub-magnet in the first direction may be spaced apart in the second direction from a virtual line extending through a center of the second sub-magnet.

The housing may have four corners when viewed in the optical axis direction, the first ball unit may be disposed at a first corner of the housing, and the second ball unit may be disposed at a second corner of the housing diagonally opposite from the first corner of the housing.

A first end of the first sub-magnet in the second direction may be disposed adjacent to the first ball unit, a second end of the first sub-magnet in the second direction may be spaced apart from a third corner of the housing in the second direction, a first end of the second sub-magnet in the second direction may be disposed adjacent to the second ball unit, a second end of the second sub-magnet in the second direction may be spaced apart from a fourth corner of the housing in the second direction, and the fourth corner of the housing may be diagonally opposite from the third corner of the housing.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is an exploded schematic perspective view of the camera module of FIG. 1.

FIG. 3 is a perspective view illustrating a state in which a lens module and a carrier are separated from a housing in the camera module of FIG. 1.

FIG. 4 is a perspective view in which the lens module and the carrier in FIG. 3 have been rotated by 180° about an optical axis (Z-axis).

FIG. 5 is a plan view illustrating a state in which a case is removed from the camera module of FIG. 1.

FIG. 6 is a cross-sectional view taken along the line VI-VI′ of FIG. 1.

FIG. 7 is an enlarged view of a portion A of FIG. 5.

FIG. 8 is a cross-sectional view taken along the line VIII-VIII′ of FIG. 1.

FIG. 9 is a top perspective view of a guide frame of a camera module of FIG. 1.

FIG. 10 is a plan view of the guide frame of FIG. 9.

FIG. 11 is a perspective view of a camera module according to another embodiment of the present disclosure.

FIG. 12 is an exploded schematic perspective view of the camera module of FIG. 11.

FIG. 13 is a perspective view illustrating a state in which a lens module and a carrier are separated from a housing in the camera module of FIG. 11.

FIG. 14 is a perspective view in which the lens module and the carrier in FIG. 13 have been rotated by 180° about an optical axis (Z-axis).

FIG. 15 is a plan view illustrating a state in which a case is removed from the camera module of FIG. 11.

FIG. 16 is a cross-sectional view taken along the line XVI-XVI′ of FIG. 11.

FIG. 17 is a cross-sectional view taken along the line XVII-XVII′ of FIG. 11.

FIG. 18 is an exploded perspective view illustrating a partial configuration of a camera module according to another embodiment of the present disclosure.

FIG. 19 is a bottom perspective view of a lens holder and a guide frame of FIG. 18.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the present disclosure, an optical axis (Z-axis) direction may refer to a direction extending along an optical axis (Z-axis) of a lens module or a direction parallel to the optical axis (Z-axis) of the lens module.

A first direction (X-axis direction) may refer to a direction perpendicular to the optical axis (Z-axis) direction, and a second direction (Y-axis direction) may refer to a direction perpendicular to both the optical axis (Z-axis) direction and the first direction (X-axis direction).

A camera module according to an embodiment of the present disclosure may be mounted in a portable electronic device. The portable electronic device may be a portable electronic device such as a mobile communication terminal, a smartphone, or a tablet PC, but is not limited thereto.

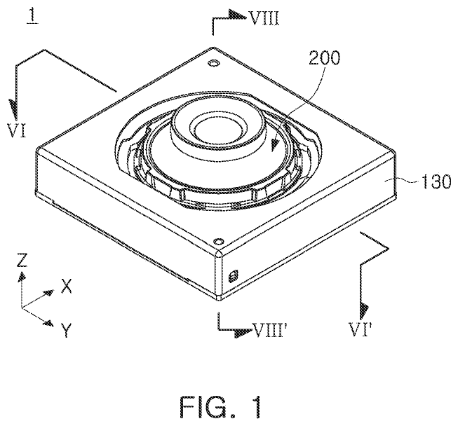

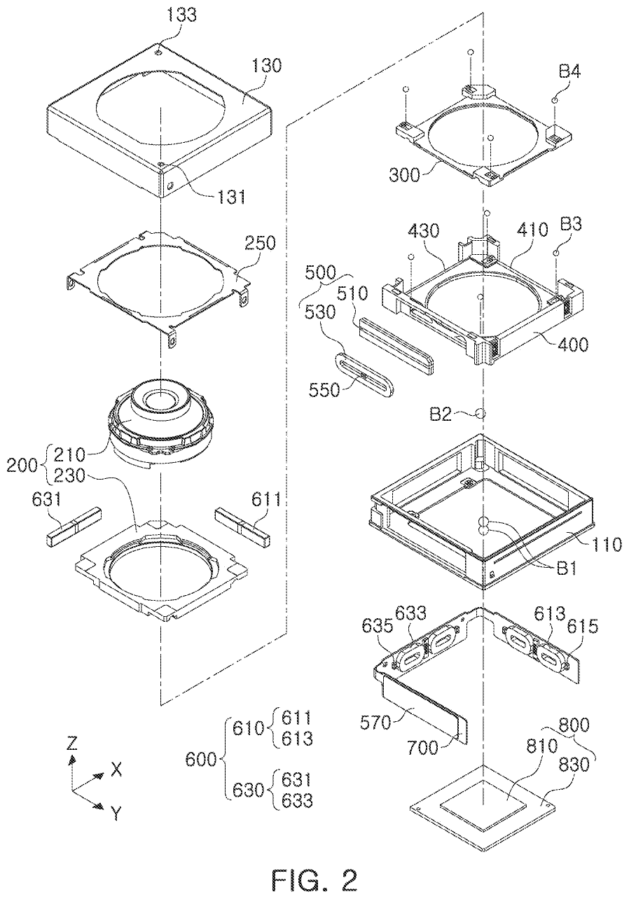

FIG. 1 is a perspective view of a camera module according to an embodiment of the present disclosure, and FIG. 2 is an exploded schematic perspective view of the camera module of FIG. 1.

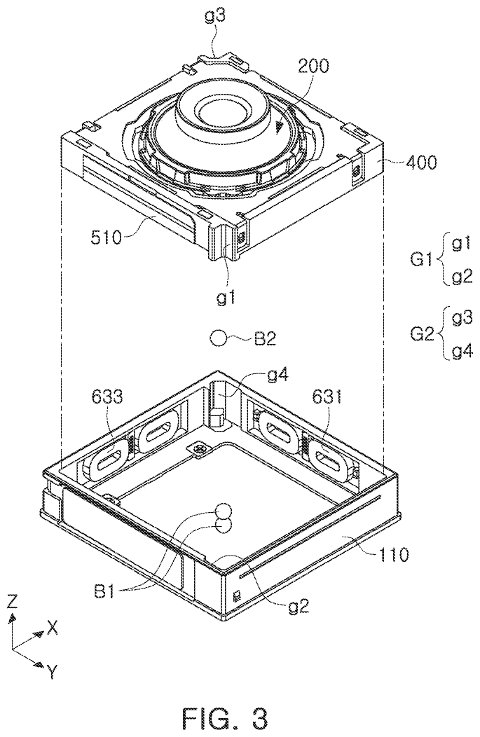

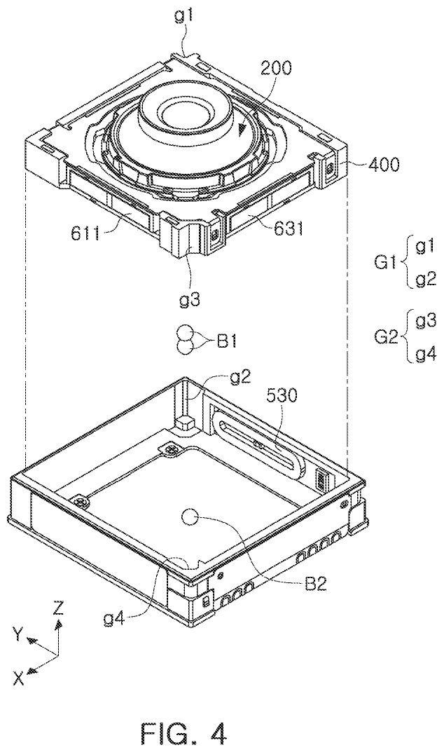

In addition, FIG. 3 is a perspective view illustrating a state in which a lens module and a carrier are separated from a housing in the camera module of FIG. 1, and FIG. 4 is a perspective view in which the lens module and the carrier in FIG. 3 have been rotated by 180° about an optical axis (Z-axis).

Referring to FIGS. 1 to 4, a camera module 1 according to an embodiment of the present disclosure may include a lens module 200, a carrier 400, a housing 110, a first driver 500, and a case 130.

The lens module 200 includes a lens barrel 210. At least one lens is disposed inside the lens barrel 210. When a plurality of lenses are provided, the plurality of lenses are mounted in the lens barrel 210 along an optical axis (Z-axis).

The lens module 200 may further include a lens holder 230 coupled to the lens barrel 210.

The lens module 200 is a moving member that moves in an optical axis (Z-axis) direction during an autofocus (AF) operation. The lens module 200 may move in the optical axis (Z-axis) direction to adjust a focus of the camera module 1.

The carrier 400 is disposed in the housing 110 and may move relative to the housing 110 in the optical axis (Z-axis) direction.

The lens module 200 is disposed in the carrier 400, and the carrier 400 and the lens module 200 may move together in the optical axis (Z-axis) direction. Accordingly, a distance between the lens module 200 and an image sensor 810 may be changed to adjust the focus.

The housing 110 may have an internal space and may have a rectangular box shape having openings in the upper and lower surfaces. The case 130 may be coupled to the housing 110 to protect the internal elements of the camera module 1.

A first protrusion 131 and a second protrusion 133 protruding toward a first ball unit B1 and a second ball unit B2 described below may be formed in the case 130. The first protrusion 131 and the second protrusion 133 may serve as stoppers and buffer members for regulating moving ranges of the first ball unit B1 and the second ball unit B2.

An image sensor module 800 may be disposed below the housing 110. The image sensor module 800 may be coupled to the housing 110.

The image sensor module 800 may include the image sensor 810 having an imaging surface, and a printed circuit board 830 connected to the image sensor 810, and may further include an infrared filter (not shown).

The infrared filter serves to block light in an infrared region among light incident through the lens module 200 from reaching the image sensor 810.

The image sensor 810 converts light incident through the lens module 200 into an electrical signal. For example, the image sensor 810 may be a charge-coupled device (CCD) or a complementary metal-oxide-semiconductor (CMOS) device.

The electrical signal converted by the image sensor 810 may be output as an image by a display unit of a portable electronic device in which the camera module 1 is mounted.

The image sensor 810 is mounted on the printed circuit board 830, and may be electrically connected to the printed circuit board 830 by wire bonding.

The first driver 500 may generate a driving force in the optical axis (Z-axis) direction to move the carrier 400 in the optical axis (Z-axis) direction.

The first driver 500 includes a first magnet 510 and a first coil 530. The first magnet 510 and the first coil 530 may face each other in a first direction (X-axis direction) perpendicular to the optical axis (Z-axis) direction.

The first magnet 510 is disposed on the carrier 400. For example, the first magnet 510 may be disposed on one side of the carrier 400.

A back yoke (not shown) may be disposed between the carrier 400 and the first magnet 510. The back yoke may increase the driving force by preventing magnetic flux of the first magnet 510 from leaking into the carrier 400.

One surface of the first magnet 510 (e.g., a surface of the first magnet 510 facing the first coil 530) may be magnetized to have both an N pole and an S pole. For example, an N pole, a neutral region, and an S pole may be sequentially arranged on the one surface of the first magnet 510 facing the first coil 530 in the optical axis (Z-axis) direction.

Another surface of the first magnet 510 (e.g., a surface of the first magnet 510 on the opposite side of the first magnet 510 from the one surface of the first magnet 510) may be magnetized to have both an S pole and an N pole. For example, an S pole, a neutral region, and an N pole may be sequentially arranged on the other surface of the first magnet 510 in the optical axis (Z-axis) direction so that the S pole on the other surface opposes the N pole on the one surface, the neutral region on the other surface opposes the neutral region on the one surface, and the N pole on the other surface opposes the S pole on the one surface.

The first coil 530 faces the first magnet 510. For example, the first coil 530 may face the first magnet 510 in the first direction (X-axis direction) perpendicular to the optical axis (Z-axis) direction.

The first coil 530 is mounted on a substrate 700, and the substrate 700 is mounted in the housing 110 so that the first magnet 510 and the first coil 530 face each other in the first direction (X-axis direction) perpendicular to the optical axis (Z-axis) direction. Accordingly, the first coil 530 may be fixed to the housing 110 through the substrate 700.

The first magnet 510 is a moving member mounted on the carrier 400 and moving with the carrier 400 in the optical axis (Z-axis) direction, and the first coil 530 is a fixed member fixed to the substrate 700.

When power is applied to the first coil 530, the carrier 400 may be moved in the optical axis (Z-axis) direction by an electromagnetic force generated between the first magnet 510 and the first coil 530.

Since the lens module 200 is accommodated in the carrier 400, the lens module 200 may also be moved in the optical axis (Z-axis) direction by the movement of the carrier 400.

The first ball unit B1 and the second ball unit B2 are disposed between the carrier 400 and the housing 110. The first ball unit B1 and the second ball unit B2 are spaced apart from each other in a diagonal direction of the carrier 400 perpendicular to the optical axis (Z-axis) direction.

Each of the first ball unit B1 and the second ball unit B2 includes at least one ball. In addition, the number of balls included in the first ball unit B1 is different from the number of balls included in the second ball unit B2.

For example, the first ball unit B1 includes two or more balls disposed in the optical axis (Z-axis) direction, and the second ball unit B2 includes a smaller number of balls than the first ball unit B1, for example, one or more balls, disposed in the optical axis (Z-axis) direction.

The first ball unit B1 and the second ball unit B2 may roll in the optical axis (Z-axis) direction when the carrier 400 moves in the optical axis (Z-axis) direction.

A first yoke 570 is disposed in the housing 110. The first yoke 570 may be disposed at a position facing the first magnet 510. For example, a first coil 530 may be disposed on one surface of the substrate 700, and a first yoke 570 may be disposed on another surface of the substrate 700 (e.g., a surface of the substrate 700 on an opposite side of the substrate 700 from the one surface of the substrate 700). Accordingly, the first yoke 570 may be disposed so that a position thereof is fixed relative to the housing 110.

An attractive force may be generated between the first magnet 510 and the first yoke 570. For example, the attractive force is generated between the first magnet 510 and the first yoke 570 in the first direction (X-axis direction) perpendicular to the optical axis (Z-axis) direction.

The first ball unit B1 and the second ball unit B2 may be held in contact with the carrier 400 and the housing 110 by the attractive force generated between the first magnet 510 and the first yoke 570.

Guide grooves may be formed in surfaces of the carrier 400 and the housing 110 facing each other. For example, a first set of guide grooves G1 may be formed in surfaces of the carrier 400 and the housing 110 facing each other on one side of the carrier 400, and a second set of guide G2 may be formed in surfaces of the carrier 400 and the housing 110 facing each other on an opposite side of the carrier 400. The first set of guide groove grooves G1 and the second set of guide grooves G2 may be spaced apart from each other in a diagonal direction of the carrier 400 perpendicular to the optical axis (Z-axis) direction.

The first set of guide grooves G1 and the second set of guide grooves G2 extend in the optical axis (Z-axis) direction. The first ball unit B1 is disposed in the first set of guide grooves G1, and the second ball unit B2 is disposed in the second set of guide grooves G2.

The first set of guide grooves G1 includes a first guide groove g1 formed in the carrier 400 and a second guide groove g2 formed in the housing 110, and the second set of guide grooves G2 includes a third guide groove g3 formed in the carrier 400 and a fourth guide groove g4 formed in the housing 110. Each of the first to fourth guide grooves g1 to g4 has a length extending in the optical axis (Z-axis) direction.

The first guide groove g1 and the second guide groove g2 face each other in the first direction (X-axis direction) perpendicular to the optical axis (Z-axis) direction, and the first ball unit B1 is disposed in a space between the first guide groove g1 and the second guide groove g2.

Among a plurality of balls included in the first ball unit B1, two balls disposed at outermost ends of the first ball unit B1 in the optical axis (Z-axis) direction may be in contact with each of the first guide groove g1 and the second guide groove g2 at two points.

That is, among the plurality of balls included in the first ball unit B1, the two balls disposed at the outermost ends of the first ball unit B1 in the optical axis (Z-axis) direction may be in two-point contact with the first guide groove g1 and two-point contact with the second guide groove g2.

The first ball unit B1, the first guide groove g1, and the second guide groove g2 may function as a main guide for guiding the movement of the carrier 400 in the optical axis (Z-axis) direction.

In addition, the third guide groove g3 and the fourth guide groove g4 face each other in the first direction (X-axis direction) perpendicular to the optical axis (Z-axis) direction, and the second ball unit B2 is disposed in a space between the third guide groove g3 and the fourth guide groove g4.

At least one ball included in the second ball unit B2 may be in two-point contact with one of the third guide groove g3 and the fourth guide groove g4 and one-point point contact with the other one of the third guide groove g3 and the fourth guide groove g4.

For example, when the second ball unit B2 includes one ball, the ball included in the second ball unit B2 may be in one-point contact with the third guide groove g3 and two-point contact with the fourth guide groove g4. Alternatively, the ball included in the second ball unit B2 may be in two-point contact with the third guide groove g3 and one-point contact with the fourth guide groove g4.

The second ball unit B2, the third guide groove g3, and the fourth guide groove g4 may function as an auxiliary guide supporting movement of the carrier 400 in the optical axis (Z-axis) direction.

When the second ball unit B2 includes three or more balls, two balls disposed at outermost ends of the second ball unit B2 in the optical axis (Z-axis) direction among the three balls may be in two-point contact with one of the third guide groove g3 and the fourth guide groove g4 and one-point contact with the other one of the third guide groove g3 and the fourth guide groove g4.

The first ball unit B1 and the second ball unit B2 are spaced apart from each other in the diagonal direction of the carrier 400 perpendicular to the optical axis (Z-axis) direction. In addition, the number of balls included in the first ball unit B1 may be different from the number of balls included in the second ball unit B2.

For example, the first ball unit B1 includes two or more balls disposed in the optical axis (Z-axis) direction, and the second ball unit B2 includes a smaller number of balls disposed in the optical axis (Z-axis) direction than the number of balls included in the first ball unit B1.

As long as the number of balls included in the first ball unit B1 is different from the number of balls included in the second ball unit B2, the number of balls in each of the first and second ball units B1 and B2 may be changed.

When the first ball unit B1 includes three balls and the second ball unit B2 includes two balls, two balls disposed at outermost ends of the first ball unit B1 in the optical axis (Z-axis) direction among the three balls included in the first ball unit B1 may have the same diameter, and one ball disposed between the two balls may have a smaller diameter than the two balls.

For example, among the plurality of balls included in the first ball unit B1, the two balls disposed at the outermost ends of the first ball unit B1 in the optical axis (Z-axis) direction have a first diameter, and the one ball disposed between the two balls has a second diameter, and the first diameter is greater than the second diameter.

Two balls included in the second ball unit B2 may have the same diameter. For example, the two balls included in the second ball unit B2 have a third diameter.

In addition, the first diameter and the third diameter may be the same. Here, having the same diameter may mean not only that the first and third diameters are exactly the same, but that they are the same within a manufacturing tolerance.

A distance between the centers of the two balls disposed at the outermost ends of the first ball unit B1 in the optical axis (Z-axis) direction among the plurality of balls included in the first ball unit B1 is different from a distance between the centers of the two balls disposed at the outermost ends of the second ball unit B2 in the optical axis (Z-axis) direction among the plurality of balls included in the second ball unit B2.

For example, a distance between the centers of the two balls in the first ball unit B1 having the first diameter is greater than a distance between the centers of the two balls in the second ball unit B2 having the third diameter.

When the first ball unit B1 includes two balls and the second ball unit B2 includes one ball, the two balls of the first ball unit B1 may have the same diameter. In addition, the diameter of the one ball of the second ball unit B2 may be equal to or different from the diameter of two balls of the first ball unit B1.

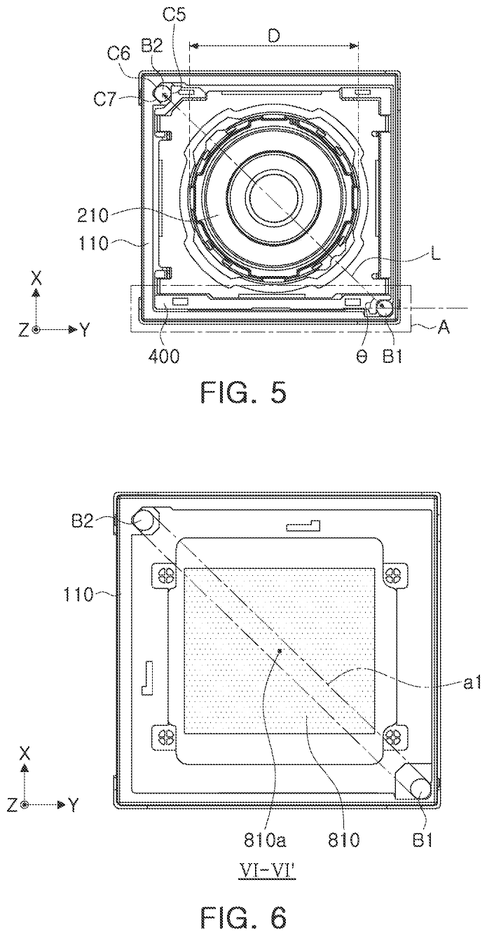

FIG. 5 is a plan view illustrating a state in which a case is removed from the camera module of FIG. 1, and FIG. 6 is a cross-sectional view taken along the line VI-VI′ of FIG. 1.

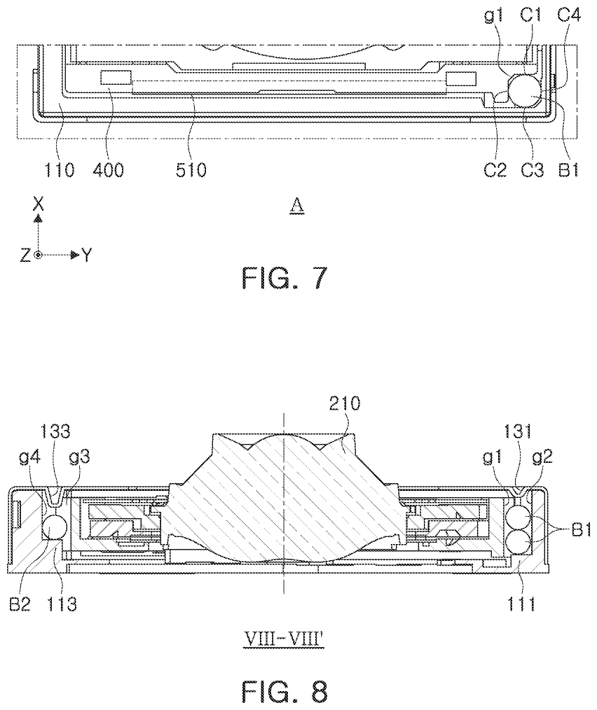

In addition, FIG. 7 is an enlarged view of a portion A of FIG. 5, and FIG. 8 is a cross-sectional view taken along the line VIII-VIII′ of FIG. 1.

Referring to FIGS. 5 and 6, the first ball unit B1 and the second ball unit B2 are spaced apart from each other in a direction perpendicular to the optical axis (Z-axis).

For example, the first ball unit B1 and the second ball unit B2 may be spaced apart from each other in a diagonal direction of the carrier 400 (or the housing 110) perpendicular to the optical axis (Z-axis) direction. Accordingly, a distance between the first ball unit B1 and the second ball unit B2 may be greater than a length of a longest side of the carrier 400.

Here, the distance between the first ball unit B1 and the second ball unit B2 may refer to the shortest distance between a ball included in the first ball unit B1 and a ball included in the second ball unit B2 when viewed in the optical axis (Z-axis) direction.

In addition, when the carrier 400 is viewed in the first direction (X-axis direction), the length of a side of the carrier 400 may refer to a distance between opposite ends of the carrier 400 in the second direction (Y-axis direction) of the side of the carrier 400. Alternatively, when the carrier 400 is viewed in the second direction (Y-axis direction), the length of a side of the carrier 400 may refer to a distance between opposite ends of the carrier 400 in the first direction (X-axis direction) of the side of the carrier 400.

In a general camera module, a plurality of balls are disposed on opposite sides of a first magnet in a longitudinal direction of the first magnet.

However, in the camera module 1 of FIG. 1, the first ball unit B1 and the second ball unit B2 are not disposed on opposite sides of the first magnet 510 in a longitudinal direction of the first magnet 510, but are spaced apart from each other in a diagonal direction of the carrier 400 perpendicular to the optical axis (Z-axis) direction.

Accordingly, the first ball unit B1 is disposed adjacent to the first magnet 510, and the second ball unit B2 is disposed at a distance from the first magnet 510 (i.e., farther away from the first magnet 510 than the first ball unit B1). A virtual line extending in the longitudinal direction of the first magnet 510 from one surface of the first magnet 510 in contact with the carrier 400 may pass through the first ball unit B1 and be spaced apart from the second ball unit B2.

When the plurality of balls are disposed on opposite sides of the first magnet in the longitudinal direction of the first magnet in the general camera module, all of the balls are pressed in the same direction (e.g., in a direction in which the first magnet and a first yoke face each other) by the attractive force generated between the first magnet and the first yoke. In addition, in a state in which the carrier is supported as described above, the carrier may move in the optical axis (Z-axis) direction.

However, since a center of the carrier is spaced apart from the surface of the carrier supported by the plurality of balls, when the carrier moves in the optical axis (Z-axis) direction, the carrier may not move parallel to the optical axis (Z-axis) and may generate a tilt.

In the camera module 1 according to an embodiment of the present disclosure, the first ball unit B1 is disposed on one of opposite sides of the first magnet 510 in the longitudinal direction of the first magnet 510, and the second ball unit B2 is spaced apart from the first ball unit B1 in the diagonal direction of the carrier 400 perpendicular to the optical axis (Z-axis) direction, thereby enabling a rotational force around the first ball unit B1 to be generated by the attractive force generated between the magnet 510 and the first yoke 570.

Accordingly, the rotational force may cause the carrier 400 to rotate about the first ball unit B1 as a rotation to hold the second ball unit B2 in contact with the carrier 400 and the housing 110.

That is, the first ball unit B1 and the second ball unit B2 may be spaced apart from each other in the diagonal direction of the carrier 400 perpendicular to the optical axis (Z-axis) direction, thereby enabling the rotational force to be generated and applied the carrier 400, and the first ball unit B1 and the second ball unit B2 may be held in contact with the carrier 400 and the housing 110 by the rotational force.

Although the rotational force is applied to the carrier 400, the carrier 400 is not rotated because the first ball unit B1 and the second ball unit B2 support the carrier 400, and the carrier 400 is supported to move in the optical axis (Z-axis) direction.

In the camera module 1 of FIG. 1, since a center of the carrier 400 may be disposed in a region in which a portion supported by the first ball unit B1 is connected to a portion supported by the second ball unit B2 (that is, because the region in which the carrier 400 is supported is not spaced apart from the center of the carrier 400), the carrier 400 may move parallel to the optical axis (Z-axis). Accordingly, a driving stability during an autofocus operation may be improved.

The center of the side of the carrier 400 on which the first magnet 510 is disposed may not coincide with the center of the first magnet 510.

For example, when viewed in the first direction (X-axis direction), the center of the first magnet 510 may be disposed closer to the first ball unit B1 than the center of the side of the carrier 400 on which the first magnet 510 is disposed. In this case, since the attractive force between the first magnet 510 and the first yoke 570 is generated at a position adjacent to the first ball unit B1, which is a main guide, the driving stability during the autofocus operation can be further improved.

Alternatively, when viewed in the first direction (X-axis direction), the center of the first magnet 510 may be disposed farther from the first ball unit B1 than the center of the side of the carrier 400 on which the first magnet 510 is disposed. In this case, since the rotational force applied to the carrier 400 may be generated more easily by the attractive force generated between the first magnet 510 and the first yoke 570, the carrier 400 may be supported more firmly.

When viewed in the optical axis (Z-axis) direction, a virtual line connecting the center of the first ball unit B1 (e.g., the center of a ball included in the first ball unit B1) and the center of the second ball unit B2 (e.g., the center of a ball included in the second ball unit B2) may form an acute angle θ with respect to a line extending from one surface of the first magnet 510 in the longitudinal direction of the first magnet 510.

When viewed in the optical axis (Z-axis) direction, the virtual line connecting the center of the first ball unit B1 and the center of the second ball unit B2 may form an acute angle θ with respect to the side of the carrier 400 on which the first magnet 510 is disposed.

When viewed in the optical axis (Z-axis) direction, the virtual line connecting the center of the first ball unit B1 and the center of the second ball unit B2 may pass through the lens module 200. Specifically, the virtual line connecting the center of the first ball unit B1 and the center of the second ball unit B2 may pass through at least one lens accommodated in the lens module 200.

When viewed in the optical axis (Z-axis) direction, a length L of the virtual line connecting the center of the first ball unit B1 and the center of the second ball unit B2 may be greater than a maximum diameter D of the lens barrel 210.

When viewed in the optical axis (Z-axis) direction, the center of the carrier 400 (or the center of the lens module 200) may be disposed in a region a1 defined by lines connecting opposite sides of the first ball unit B1 to opposite sides of the second ball unit B2.

When viewed in the optical axis (Z-axis) direction, the center 810a of the image sensor 810 (e.g., the center 810a of an effective imaging surface of the image sensor 810) may be disposed in the region a1 defined by the lines connecting the opposite sides of the first ball unit B1 to the opposite sides of the second ball unit B2.

Referring to FIGS. 3 and 4, the first set of guide grooves G1 and the second set of guide grooves G2 may be disposed between the carrier 400 and the housing 110.

The first set of guide grooves G1 includes the first guide groove g1 formed in the carrier 400 and the second guide groove g2 formed in the housing 110 and facing the first guide groove g1, and the second set of guide grooves G2 includes the third guide groove g3 formed in the carrier 400 and the fourth guide groove g4 formed in the housing 110 and facing the third guide groove g3.

The first ball unit B1 is disposed between the first guide groove g1 and the second guide groove g2, and the second ball unit B2 is disposed between the third guide groove g3 and the fourth guide groove g4.

A direction in which the first guide groove g1 and the second guide groove g2 face each other is different from a direction in which the third guide groove g3 and the fourth guide groove g4 face each other.

For example, the center of the first guide groove g1 and the center of the second guide groove g2 may face each other in the diagonal direction of the carrier 400 perpendicular to the optical axis (z-axis) direction, and the center of the third guide groove g3 and the center of the fourth guide groove g4 may face each other in the second direction (Y-axis direction).

Referring to FIG. 7, the first ball unit B1 contacts the first guide groove g1 at a first contact point C1 and a second contact point C2, and contacts the second guide groove g2 at a third contact point C3 and a fourth contact point C4.

The first contact point C1 and the third contact point C3 may face each other in the first direction (X-axis direction) perpendicular to the optical axis (Z-axis) direction. The second contact point C2 and the fourth contact point C4 may face each other in the second direction (Y-axis direction) perpendicular to both the optical axis (Z-axis) direction and the first direction (X-axis direction).

When viewed in the optical axis (Z-axis) direction, the first guide groove g1 may have a substantially ‘┌’ shape and the second guide groove g2 may have a substantially ‘┘’ shape.

Referring to FIG. 5, the second ball unit B2 contacts the third guide groove g3 at a fifth contact point C5, and contacts the fourth guide groove g4 at a sixth contact point C6 and a seventh contact point C7.

When viewed in the optical axis (Z-axis) direction, the third guide groove g3 may have a substantially ‘|’ shape, and the fourth guide groove g4 may have a substantially ‘<’ shape.

The length of the first set of guide grooves G1 in the optical axis (Z-axis) direction may be different from the length of the second set of guide grooves G2 in the optical axis (Z-axis) direction.

For example, referring to FIG. 8, the length of the second guide groove g2 formed in the housing 110 in the optical axis (Z-axis) direction may be longer than the length of the fourth guide groove g4 formed in the housing 110 in the optical axis (Z-axis) direction. To this end, a first support protrusion 111 protruding toward the first ball unit B1 and a second support protrusion 113 protruding toward the second ball unit B2 may be formed on a bottom surface of the housing 110. The length of the second support protrusion 113 in the optical axis (Z-axis) direction may be longer than the length of the first support protrusion 111 in the optical axis (Z-axis) direction.

In addition, a first protrusion 131 protruding toward the first ball unit B1 and a second protrusion 133 protruding toward the second ball unit B2 may be formed in the case 130. The length of the second protrusion 133 in the optical axis (Z-axis) direction may be longer than the length of the first protrusion 131 in the optical axis (Z-axis) direction.

The camera module 1 may sense a position of the carrier 400 in the optical axis (Z-axis) direction.

To this end, a first position sensor 550 is provided. The first position sensor 550 is disposed on the substrate 700 facing the first magnet 510. The first position sensor 550 may be a Hall sensor.

The camera module 1 may correct shaking during photographing by moving the lens module 200 in a direction perpendicular to the optical axis (Z-axis) direction. To this end, referring to FIG. 2, the camera module 1 includes a second driver 600 that moves the lens module 200 in a direction perpendicular to the optical axis (Z-axis) direction.

Referring to FIG. 2, a guide frame 300 and the lens module 200 may be sequentially disposed in the carrier 400. For example, the guide frame 300 may be disposed between the carrier 400 and the lens module 200. The guide frame 300 may have a rectangular plate shape having a hole.

The guide frame 300 and the lens module 200 may be moved together in the first direction (X-axis direction) by a driving force generated in the first direction (X-axis direction) by the second driver 600, and the lens module 200 may be moved relative to the guide frame 300 in the second direction (Y-axis direction) by a driving force generated in the second direction (Y-axis direction) by the second driver 600.

The second driver 600 includes a first sub-driver 610 and a second sub-driver 630. The first sub-driver 610 may generate the driving force in the first direction (X-axis direction), and the second sub-driver 630 may generate the driving force in the second direction (Y-axis direction).

The first sub-driver 610 includes a second magnet 611 and a second coil 613. The second magnet 611 and the second coil 613 may face each other in the first direction (X-axis direction).

The second magnet 611 may be disposed on the lens module 200. For example, the second magnet 611 may be disposed on one side of the lens holder 230.

The second coil 613 is faces the second magnet 611. For example, the second coil 613 may face the second magnet 611 in the first direction (X-axis direction).

The second coil 613 may have a donut shape having a hole. The second coil 613 may include a plurality of coils. For example, the second coil 613 may include two coils each having a donut shape having a hole and spaced apart from each other in the second direction (Y-axis direction), and each of the two coils may face the second magnet 611.

In addition, polarities of surface of the second magnet 611 facing the two coils of the second coil 613 may be different from each other. For example, one of the two coils may face an N pole of the second magnet 611, and the other one of the two coils may face an S pole of the second magnet 611.

When correcting the shaking, the second magnet 611 is a moving member mounted on the lens holder 230, and the second coil 613 is a fixed member fixed to the housing 110.

When power is applied to the second coil 613, the lens module 200 and the guide frame 300 may be moved in the first direction (X-axis direction) by an electromagnetic force generated between the second magnet 611 and the second coil 613.

The second magnet 611 and the second coil 613 may generate the driving force in the first direction (X-axis direction) in which the second magnet 611 and the second coil 613 face each other.

The second sub-driver 630 includes a third magnet 631 and a third coil 633. The third magnet 631 and the third coil 633 may face each other in the second direction (Y-axis direction).

The third magnet 631 may be disposed on the lens module 200. For example, the third magnet 631 may be disposed on another side of the lens holder 230 adjacent to the side of the lens holder 230 on which the first magnet 611 is disposed.

The third coil 633 faces the third magnet 631. For example, the third coil 633 may face the third magnet 631 in the second direction (Y-axis direction).

The third coil 633 may have a donut shape having a hole. The third coil 633 may include a plurality of coils. For example, the third coil 633 may include two coils each having a donut shape having a hole and spaced apart from each other in the first direction (X-axis direction), and each of the two coils may face the third magnet 631.

In addition, polarities of a surface of the third magnet 631 facing the two coils of the third coil 633 may be different from each other. For example, one of the two coils may face an N pole of the third magnet 631, and the other one of the two coils may face an S pole of the third magnet 631.

The second coil 613 and the third coil 633 may be disposed on the substrate 700. For example, the second coil 613 and the third coil 633 may be disposed on the substrate 700 to face the second magnet 611 and the third magnet 631.

The substrate 700 is mounted on three sides of the housing 110, and the second coil 613 and the third coil 633 may directly face the second magnet 611 and the third magnet 631 through openings in two sides of the housing 110. The substrate 700 may have a substantially shape when viewed in the optical axis (Z-axis) direction.

The first ball unit B1 is disposed at one corner of the housing 110, and the second ball unit B2 is disposed at the an opposite corner of the housing 110. The substrate 700 may be disposed to surround the opposite corner of the housing 110 at which the second ball unit B2 is disposed.

When correcting the shaking, the third magnet 631 is a moving member mounted on the lens holder 230, and the third coil 633 is a fixed member fixed to the housing 110.

When power is applied to the third coil 633, the lens module 200 may be moved in the second direction (Y-axis direction) by an electromagnetic force generated between the third magnet 631 and the third coil 633.

The third magnet 631 and the third coil 633 may generate the driving force in the second direction (Y-axis direction) in which the third magnet 631 and the third coil 633 face each other.

The second magnet 611 and the third magnet 631 are disposed perpendicular to each other on a plane perpendicular to the optical axis (Z-axis), and the second coil 613 and the third coil 633 are also disposed perpendicular to each other on the plane perpendicular to the optical axis (Z-axis).

The second magnet 611 and the third magnet 631 may be disposed closer to the second ball unit B2 than to the first ball unit B1.

A virtual line extending in the longitudinal direction of the second magnet 611 from one surface of the second magnet 611 in contact with the lens holder 230 may pass through the second ball unit B2 and may be spaced apart from the first ball unit B1. In addition, a virtual line extending in the longitudinal direction of the third magnet 631 from one surface of the third magnet 631 in contact with the lens holder 230 may pass through the second ball unit B2 and may be spaced apart from the first ball unit B1.

The camera module 1 of FIG. 1 is provided with a plurality of ball units supporting the guide frame 300 and the lens module 200. The plurality of ball units function to guide the movement of the guide frame 300 and the lens module 200 during the process of correcting the shaking. The plurality of ball units also function to maintain a gap between the carrier 400 and the guide frame 300, and a gap between the guide frame 300 and the lens module 200.

The plurality of ball units include a third ball unit B3 and a fourth ball unit B4.

The third ball unit B3 guides the movement of the guide frame 300 and the lens module 200 in the first direction (X-axis direction), and the fourth ball unit B4 guides the movement of the lens module 200 in the second direction (Y-axis direction).

For example, when a driving force is generated in the first direction (X-axis direction), the third ball unit B3 rolls in the first direction (X-axis direction). Accordingly, the third ball unit B3 guides the movement of the guide frame 300 and the lens module 200 in the first direction (X-axis direction).

When a driving force is generated in the second direction (Y-axis direction), the fourth ball unit B4 rolls in the second direction (Y-axis direction). Accordingly, the fourth ball unit B4 guides the movement of the lens module 200 in the second direction (Y-axis direction).

The third ball unit B3 includes a plurality of balls disposed between the carrier 400 and the guide frame 300, and the fourth ball unit B4 includes a plurality of balls disposed between the guide frame 300 and the lens module 200.

For example, referring to FIG. 2, each of the third ball unit B3 and the fourth ball unit B4 may include four balls.

A third set of guide grooves G3 accommodating the third ball unit B3 is formed in at least one of the surfaces of the carrier 400 and the guide frame 300 facing each other in the optical axis (Z-axis) direction. The third set of guide grooves G3 includes a plurality of guide grooves corresponding to the plurality of balls of the third ball unit B3.

The third ball unit B3 is accommodated in the third set of guide grooves G3 and is disposed between the carrier 400 and the guide frame 300.

In a state in which the third ball unit B3 is accommodated in the third set of guide grooves G3, the movement of the third ball unit B3 in the optical axis (Z-axis) direction and the second direction (Y-axis direction) may be limited, and the third ball unit B3 may move only in the first direction (X-axis direction). For example, the third ball unit B3 may roll only in the first direction (X-axis direction).

To this end, a planar shape of each of the plurality of guide grooves of the third set of guide grooves G3 may be a rectangular shape having a length extending in the first direction (X-axis direction).

A fourth set of guide grooves G4 accommodating the fourth ball unit B4 is formed in at least one of the surfaces of the guide frame 300 and the lens module 200 (e.g., the lens holder 230) facing each other in the optical axis (Z-axis) direction. The fourth set of guide grooves G4 includes a plurality of guide grooves corresponding to the plurality of balls of the fourth ball unit B4.

The fourth ball unit B4 is accommodated in the fourth set of guide grooves G4 and is inserted between the guide frame 300 and the lens module 200.

In a state in which the fourth ball unit B4 is accommodated in the fourth set of guide grooves G4, the movement of the fourth ball unit B4 in the optical axis (Z-axis) direction and the first direction (X-axis direction) may be limited, and the fourth ball unit B4 may move only in the second direction (Y-axis direction). For example, the fourth ball unit B4 may roll only in the second direction (Y-axis direction).

To this end, a planar shape of each of the plurality of guide grooves of the fourth set of guide grooves G4 may be a rectangular shape having a length extending in the second direction (Y-axis direction).

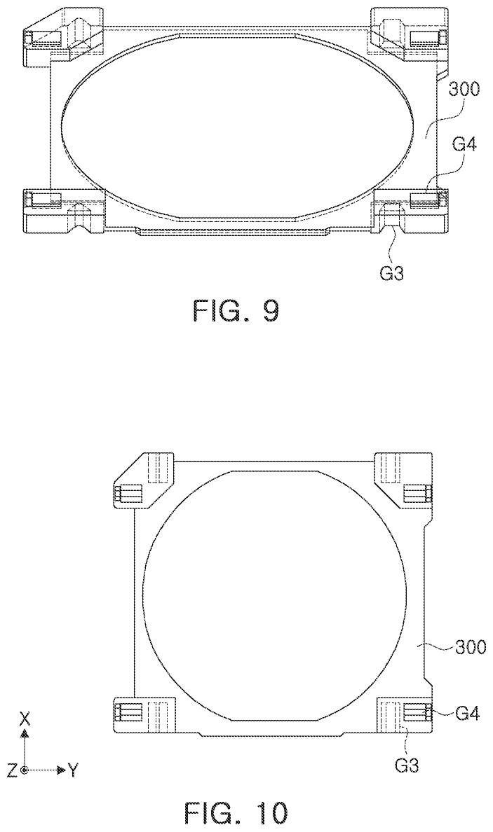

FIG. 9 is a top perspective view of a guide frame of the camera module of FIG. 1, and FIG. 10 is a plan view of the guide frame of FIG. 9.

The third set of guide grooves G3 in which the third ball unit B3 is disposed may be formed in a lower surface of the guide frame 300 facing the carrier 400 in the optical axis (Z-axis) direction. The two guide grooves G3 on the left side of the guide frame 300 in FIGS. 9 and 10 may have the same shape as each other, and the two guide grooves G3 on the right side of the guide frame 300 in FIGS. 9 and 10 may have the same shape as each other. Also, the shape of the two guide grooves G3 on the left side of the guide frame 300 may be different from the shape of the two guide grooves G3 on the right side of the guide frame 300. In addition, the set of fourth guide grooves G4 in which the fourth ball unit B4 is disposed may be formed in an upper surface of the guide frame 300 facing the lens module 200 in the optical axis (Z-axis) direction.

The third set of guide grooves G3 and the fourth set of guide grooves G4 may be disposed at positions at which they do not overlap each other when viewed in the optical axis (Z-axis) direction.

Since the third ball unit B3 and the fourth ball unit B4 are accommodated in the third set of guide grooves G3 and the fourth set of guide grooves G4, the third set of guide grooves G3 and the fourth set of guide grooves G4 each have a predetermined depth. Therefore, if the third set of guide grooves G3 and the fourth set of guide grooves G4 are arranged to overlap each other in the optical axis (Z-axis) direction, the guide frame 300 must be made thick in the optical axis (Z-axis) direction, which may cause an increase in the height of the camera module 1 in the optical axis (Z-axis) direction.

However, in the camera module 1 of FIG. 1, the guide frame 300 may be made relatively thin in the optical axis (Z-axis) direction by arranging the third set of guide grooves G3 and the fourth set of guide grooves G4 so they do not overlap each other in the optical axis (Z-axis) direction, thereby decreasing the height of the camera module 1 in the optical axis (Z-axis) direction.

The third set of guide grooves G3 and the fourth set of guide grooves G4 may be disposed at positions at which they do not overlap each other in the first direction (X-axis direction). In addition, the third set of guide grooves G3 and the fourth set of guide grooves G4 may be arranged so that some of the guide grooves of the third set of guide grooves G3 and some of the guide grooves of the fourth set of guide grooves G4 overlap each other in the second direction (Y-axis direction), and the other guide grooves of the third set of guide grooves G3 and the other guide grooves of the fourth set of guide grooves G4 do not overlap each other in the second direction (Y-axis direction).

One of the four corners of the guide frame 300 may have a chamfered shape. For example, a corner of the carrier 400 at which the second ball unit B2 is disposed and an adjacent corner of the guide frame 300 may have a chamfered shape.

When a driving force is generated in the first direction (X-axis direction), the guide frame 300 and the lens module 200 move together in the first direction (X-axis direction), and the third ball unit B3 rolls in the first direction (X-axis direction). In this case, a movement of the fourth ball unit B4 is limited.

In addition, when a driving force is generated in the second direction (Y-axis direction), the lens module 200 moves relative to the guide frame 300 in the second direction (Y-axis direction), and the fourth ball unit B4 rolls in the second direction (Y-axis direction). In this case, a movement of the third ball unit B3 is limited.

The camera module 1 may sense a position of the lens module 200 in a direction perpendicular to the optical axis (Z-axis) direction.

To this end, a second position sensor 615 and a third position sensor 635 are provided. The second position sensor 615 may be mounted on the substrate 700 facing the second magnet 611, and the third position sensor 635 may be mounted on the substrate 700 facing the third magnet 631. The second position sensor 615 and the third position sensor 635 may be Hall sensors.

At least one of the second position sensor 615 and the third position sensor 635 may include two Hall sensors. For example, the second position sensor 615 includes two Hall sensors mounted on the substrate 700 and facing the second magnet 611.

Whether the lens module 200 rotates may be sensed through the two Hall sensors of the second position sensor 615 facing the second magnet 611. Since the second coil 613 includes two coils facing the second magnet 611, the second coil 613 may be controlled to offset a rotational force applied to the lens module 200.

The lens module 200 may be prevented from rotating by the configuration of the third set of guide grooves G3 and the fourth set of guide grooves G4 in which the third ball unit B3 and the fourth ball unit B4 are disposed, but the lens module 200 may be finely rotated due to the influence of slight variations within a tolerance occurring during the manufacturing process of the camera module 1.

However, the camera module 1 may offset any rotation of the lens module 200 by detecting the rotation of the lens module 200 with the second position sensor 615 and controlling the second coil 613 to apply a rotational force to the lens module 200 to counteract the rotation of the lens module 200.

A second yoke 410 and a third yoke 430 are provided so that the carrier 400 and the guide frame 300 may remain in contact with the third ball unit B3, and the guide frame 300 and the lens module 200 may remain in contact with the fourth ball unit B4.

The second yoke 410 and the third yoke 430 are mounted on the carrier 400 so that they face the second magnet 611 and the third magnet 631 in the optical axis (Z-axis) direction.

Accordingly, an attractive force is generated between the second yoke 410 and the second magnet 611 in the optical axis (Z-axis direction, and an attractive force is generated between the third yoke 430 and the third magnet 631 in the optical axis (Z-axis) direction.

Since the lens module 200 and the guide frame 300 are pressed in a direction toward the second yoke 410 and the third yoke 430 by the attractive force generated between the second yoke 410 and the second magnet 611 and the attractive force generated between the third yoke 430 and the third magnet 631, the guide frame 300 and the lens module 200 may remain in contact with the third ball unit B3 and the fourth ball unit B4.

The second yoke 410 and the third yoke 430 are made of a material that may generate the attractive forces with the second magnet 611 and the third magnet 631. For example, the second yoke 410 and the third yoke 430 may be magnetic bodies.

A stopper 250 is coupled to the carrier 400 to cover at least a portion of an upper surface of the lens module 200. For example, the stopper 250 may cover at least a portion of the upper surface of the lens holder 230.

The stopper 250 may prevent the guide frame 300 and the lens module 200 from being separated from the carrier 400 due to an external impact or other disturbance.

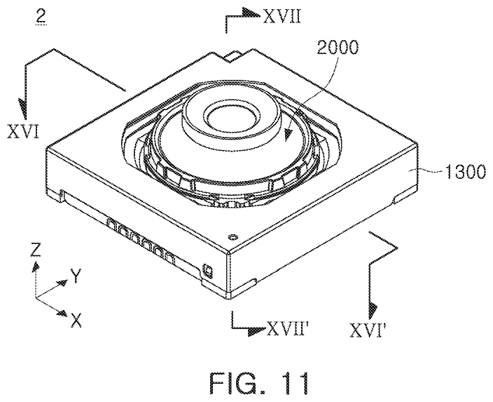

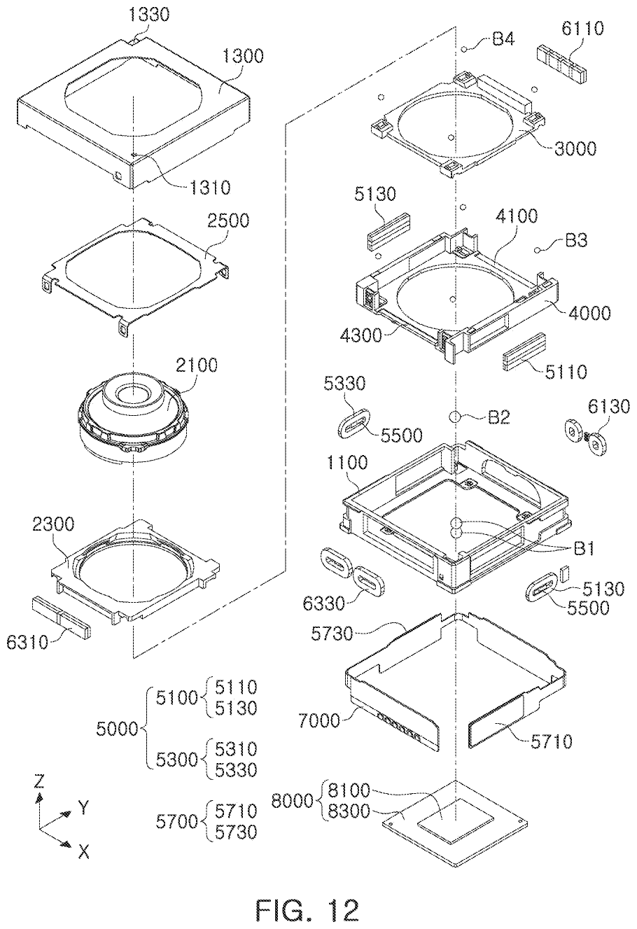

FIG. 11 is a perspective view of a camera module according to another embodiment of the present disclosure, and FIG. 12 is an exploded schematic perspective view of the camera module of FIG. 11.

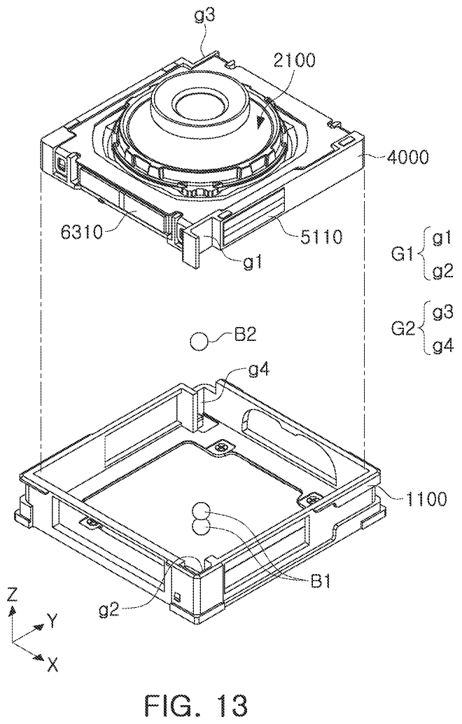

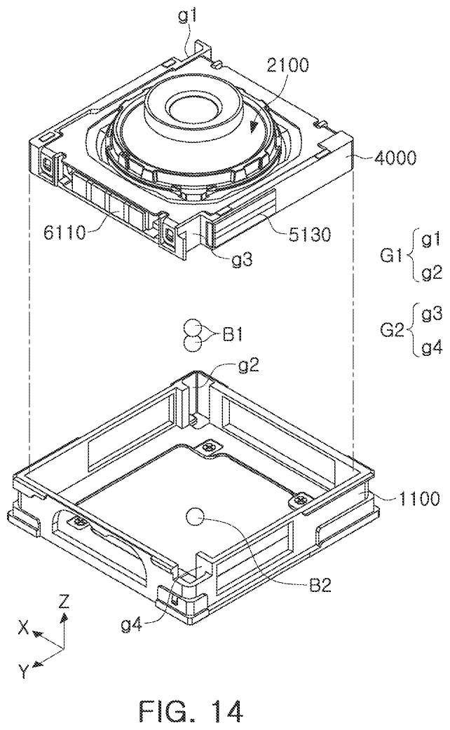

In addition, FIG. 13 is a perspective view illustrating a state in which a lens module and a carrier are separated from a housing in the camera module of FIG. 13, and FIG. 14 is a perspective view in which the lens module and the carrier in FIG. 13 have been rotated by 180° about an optical axis (Z-axis).

Referring to FIGS. 11 to 14, a camera module 2 according to another embodiment of the present disclosure may include a lens module 2000, a carrier 4000, a housing 1100, a first driver 5000, and a case 1300.

The lens module 2000 includes a lens barrel 2100. At least one lens is disposed inside the lens barrel 2100. When a plurality of lenses are provided, the plurality of lenses are mounted in the lens barrel 2100 along an optical axis (Z-axis).

The lens module 2000 may further include a lens holder 2300 coupled to the lens barrel 2100.

The lens module 2000 is a moving member that moves in an optical axis (Z-axis) direction during an autofocus (AF) operation. The lens module 2000 may move in the optical axis (Z-axis) direction to adjust a focus of the camera module 2.

The carrier 4000 is disposed in the housing 1100 and may move relative to the housing 1100 in the optical axis (Z-axis) direction.

The lens module 2000 is disposed in the carrier 4000, and the carrier 4000 and the lens module 2000 may move together in an optical axis (Z-axis) direction. Accordingly, a distance between the lens module 2000 and an image sensor 8100 may be changed to adjust the focus.

The housing 1100 may have an internal space and may have a rectangular box shape having openings in the upper and lower surfaces. The case 1300 may be coupled to the housing 1100 to protect the internal elements of the camera module 2.

The case 1300 may include a protrusion 1310 protruding toward the first ball unit B1 and a step portion 1330 protruding toward the second ball unit B2. The protrusion 1310 and the step portion 1330 are described below. The protrusion 1310 and the step portion 1330 may serve stoppers and buffer members for regulating the moving ranges of the first ball unit B1 and the second ball unit B2.

The protrusion portion 1310 may protrude toward the first ball unit B1 in the optical axis (Z-axis) direction, and the step portion 1330 may protrude toward the second ball unit B2 in the optical axis (Z-axis) direction. A protruding amount of the protrusion portion 1310 protruding toward the first ball unit B1 may be different from a protruding amount of the step portion 1330 protruding toward the second ball unit B2.

For example, the length of the step portion 1330 in the optical axis (Z-axis) direction may be longer than the length of the protrusion portion 1310 in the optical axis (Z-axis) direction.

An image sensor module 8000 may be disposed below the housing 1100. The image sensor module 8000 may be coupled to the housing 1100.

The image sensor module 8000 may include the image sensor 8100 having an imaging surface and a printed circuit board 8300 connected to the image sensor 8100, and may further include an infrared filter (not show)n.

The infrared filter serves to block light in an infrared region among light incident through the lens module 2000 from reaching the image sensor 8100.

The image sensor 8100 converts light incident through the lens module 2000 into an electrical signal. For example, the image sensor 8100 may be a charge-coupled device (CCD) or a complementary metal-oxide-semiconductor (CMOS) device.

The electrical signal converted by the image sensor 8100 may be output as an image through a display unit of a portable electronic device in which the camera module 2 is mounted.

The image sensor 8100 is mounted on the printed circuit board 8300, and may be electrically connected to the printed circuit board 8300 by wire bonding.

The first driver 5000 may generate a driving force in the optical axis (Z-axis) direction and move the carrier 4000 in the optical axis (Z-axis) direction.

The first driver 5000 includes a first magnet 5100 and a first coil 5300. The first magnet 5100 and the first coil 5300 may face each other in a first direction (X-axis direction) perpendicular to the optical axis (Z-axis) direction.

The first magnet 5100 is disposed on the carrier 4000. For example, the first magnet may be disposed on one side of the carrier 4000.

A back yoke (not shown) may be disposed between the carrier 4000 and the first magnet 5100. The back yoke may increase the driving force by preventing magnetic flux of the first magnet 5100 from leaking into the carrier 4000.

One surface of the first magnet 5100 (e.g., a surface of the first magnet 5100 facing the first coil 5300) may be magnetized to have both an N pole and an S pole. For example, an N pole, a neutral region, and an S pole may be sequentially arranged on the one surface of the first magnet 5100 facing the first coil 5300 in the optical axis (Z-axis) direction.

Another surface of the first magnet 5100 (e.g., a surface of the first magnet 5100 on the opposite side of the first magnet 5100 from the one surface of the first magnet 5100) may be magnetized to have both an S pole and an N pole. For example, an S pole, a neutral region, and an N pole may be sequentially arranged on the other surface of the first magnet 5100 along the optical axis (Z-axis) direction so that the S pole on the other surface opposes the N pole on the one surface, the neutral region on the other surface opposes the neutral region on the one surface, and the N pole on the other surface opposes the S pole on the one surface.

The first magnet 5100 includes a first sub-magnet 5110 and a second sub-magnet 5130. The first sub-magnet 5110 is disposed on one side of the carrier 4000, and the second sub-magnet 5130 is disposed on an opposite side of the carrier 4000.

The first coil 5300 faces the first magnet 5100. For example, the first coil 5300 may face the first magnet 5100 in the first direction (X-axis direction) perpendicular to the optical axis (Z-axis) direction.

The first coil 5300 is mounted on a substrate 7000, and the substrate 7000 is mounted in the housing 1100 so that the first magnet 5100 and the first coil 5300 face each other in the first direction (X-axis direction) perpendicular to the optical axis (Z-axis) direction. Accordingly, the first coil 5300 may be fixed to the housing 1100 through the substrate 7000.

The first coil 5300 includes a first sub-coil 5310 mounted on the substrate 7000 and facing the first sub-magnet 5110 and a second sub-coil 5330 mounted on the substrate 7000 and facing the second sub-magnet 5130.

The first magnet 5100 is a moving member mounted on the carrier 4000 and moving with the carrier 4000 in the optical axis (Z-axis) direction, and the first coil 5300 is a fixed member fixed to the substrate 7000.

When power is applied to the first coil 5300, the carrier 4000 may be moved in the optical axis (Z-axis) direction by an electromagnetic force generated between the first magnet 5100 and the first coil 5300.

Since the lens module 2000 is accommodated in the carrier 4000, the lens module 2000 may also be moved in the optical axis (Z-axis) direction by the movement of the carrier 4000.

The first ball unit B1 and the second ball unit B2 are disposed between the carrier 4000 and the housing 1100. Since the configurations of the first ball unit B1 and the second ball unit B2 of the camera module of FIG. 11 are similar to the configurations of the first ball unit B1 and the second ball unit B2 of the camera module 1 of FIG. 1 described above with reference to FIGS. 1 to 10, a detailed description thereof will be omitted.

A first yoke 5700 is disposed in the housing 1100. The first yoke 5700 may be disposed at a position facing the first magnet 5100. For example, the first coil 5300 may be disposed on one surface of the substrate 7000, and the first yoke 5700 may be disposed on another surface of the substrate 7000 (e.g., a surface of the substrate 7000 on an opposite side of the substrate 7000 from the one surface of the substrate 7000). Accordingly, the first yoke 5700 may be disposed so that a position thereof is fixed relative to the housing 1100.

An attractive force may be generated between the first magnet 5100 and the first yoke 5700. For example, the attractive force is generated between the first magnet 5100 and the first yoke 5700 in the first direction (X-axis direction) perpendicular to the optical axis (Z-axis) direction.

The first ball unit B1 and the second ball unit B2 may be held in contact with the carrier 4000 and the housing 1100 by the attractive force generated between the first magnet 5100 and the first yoke 5700.

The first yoke 5700 includes a first sub-yoke 5710 facing the first sub-magnet 5110 and a second sub-yoke 5730 facing the second sub-magnet 5130.

An attractive force is generated between the first sub-magnet 5110 and the first sub-yoke 5710, and an attractive force is generated between the second sub-magnet 5130 and the second sub-yoke 5730.

Guide grooves may be formed in surfaces of the carrier 4000 and the housing 1100 facing each other. For example, a first set of guide grooves G1 may be formed in surfaces of the carrier 4000 and the housing 1100 facing each other on one side of the carrier 4000, and a second set of guide grooves G2 may be formed in surfaces of the carrier 4000 and the housing 1100 facing each other on an opposite side of the carrier 4000. The first set of guide grooves G1 and the second set of guide grooves G2 may be spaced apart from each other in a diagonal direction of the carrier 4000 perpendicular to the optical axis (Z-axis) direction.

The first set of guide grooves G1 and the second set of guide grooves G2 extend in the optical axis (Z-axis) direction. The first ball unit B1 is disposed in the first set of guide grooves G1, and the second ball unit B2 is disposed in the second set of guide grooves G2.

The first set of guide grooves G1 includes a first guide groove g1 formed in the carrier 4000 and a second guide groove g2 formed in the housing 1100, and the second set of guide grooves G2 includes a third guide groove g3 formed in the carrier 4000 and a fourth guide groove g4 formed in the housing 1100.

The first ball unit B1 is disposed between the first guide groove g1 and the second guide groove g2, and the second ball unit B2 is disposed between the third guide groove g3 and the fourth guide groove g4.

The center of the first guide groove g1 and the center of the second guide groove g2 may face each other in the diagonal direction of the carrier 4000 perpendicular to the optical axis (Z-axis) direction, and the center of the third guide groove g3 and the center of the fourth guide groove g4 may face each other in the diagonal direction of the carrier 4000 perpendicular to the optical axis (Z-axis) direction.

Since the configuration of the first to fourth guide grooves g1 to g4 is similar to the configurations of the first to fourth guide grooves g1 to g4 of the camera module 1 of FIG. 1 described above with reference to FIGS. 1 to 10, a detailed description thereof will be omitted.

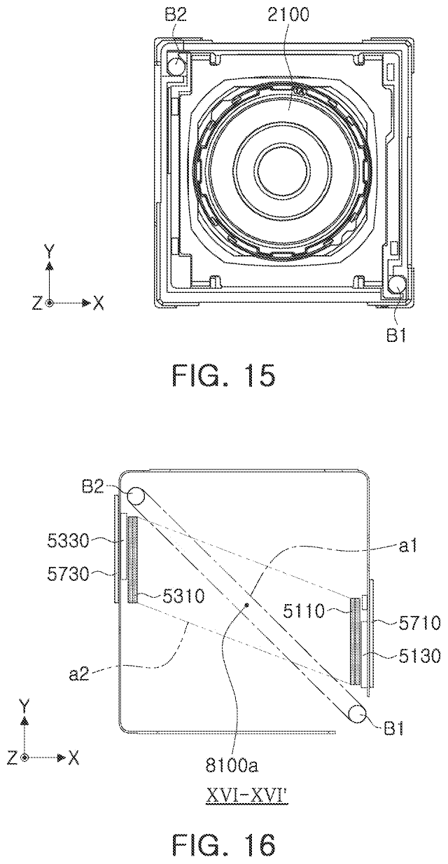

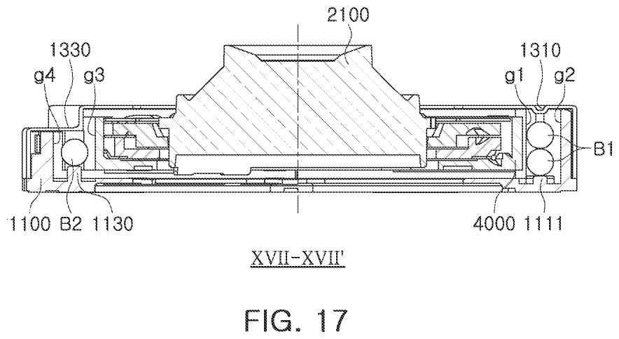

FIG. 15 is a plan view illustrating a state in which a case is removed from the camera module FIG. 11, FIG. 16 is a cross-sectional view taken along the line XVI-XVI′ of FIG. 11, and FIG. 17 is a cross-sectional view taken along the line XVII-XVII′ of FIG. 11.

Referring to FIGS. 15 to 17, the first ball unit B1 and the second ball unit B2 are spaced apart from each other in a direction perpendicular to the optical axis (Z-axis) direction.

For example, the first ball unit B1 and the second ball unit B2 may be spaced apart from each other in the diagonal direction of the carrier 4000 (or the housing 1100) perpendicular to the optical axis (Z-axis) direction. Accordingly, a distance between the first ball unit B1 and the second ball unit B2 may be greater than a length of a longest side of the carrier 4000.

The first ball unit B1 is disposed adjacent to the first sub-magnet 5110, and the second ball unit B2 is disposed adjacent to the second sub-magnet 5130.

A virtual line extending in the longitudinal direction of the first sub-magnet 5110 from one surface of the first sub-magnet 5110 in contact with the carrier 4000 may pass through the first ball unit B1 and may be spaced apart from the second ball unit B2. In addition, a virtual line extending in the longitudinal direction of the second sub-magnet 5130 from one surface of the second sub-magnet 5130 in contact with the carrier 4000 may pass through the second ball unit B2 and be spaced apart from the first ball unit B1.

The first sub-magnet 5110 may be disposed adjacent to the first ball unit B1 on one side of the carrier 4000. For example, the first sub-magnet 5110 may be disposed on the one side of the carrier 4000 so that a center of the first sub-magnet 5110 is offset from a center of the one side of the carrier 4000 toward the first ball unit B1 in the longitudinal direction (i.e., the second direction (Y-axis direction)) of the first sub-magnet 5110. That is, the center of the first sub-magnet 5110 may be closer to the first ball unit B1 than the center of the one side of the carrier 4000.

The second sub-magnet 5130 may be disposed adjacent to the second ball unit B2 on the another side of the carrier 4000 on an opposite side of the carrier 4000 from the one side of the carrier 4000 on which the first sub-magnet 5110 is mounted. For example, the second sub-magnet 5130 may be disposed on the other side of the carrier 4000 so that a center of the second sub-magnet 5130 is offset from a center of the other side of the carrier 4000 toward the second ball unit B2 in the longitudinal direction (i.e., the second direction (Y-axis direction)) of the second sub-magnet 5130. That is, the center of the second sub-magnet 5130 may be closer to the second ball unit B2 than the center of the other side of the carrier 4000.

An attractive force is generated between the first sub-magnet 5110 and the first sub-yoke 5710, and an attractive force is generated between the second sub-magnet 5130 and the second sub-yoke 5730.

Since the center of the first sub-magnet 5110 is offset from the center of the one side of the carrier 4000 toward the first ball unit B1 and the center of the second sub-magnet 5130 is offset from the center of the other side of the carrier 4000 toward the second ball unit B2, a rotational force may be applied to the carrier 4000 by the attractive force generated between the first sub-magnet 5110 and the first sub-yoke 5710, and the attractive force generated between the second sub-magnet 5130 and the second sub-yoke 5730.

Due to such a rotational force, the first ball unit B1 and the second ball unit B2 are held in contact with the carrier 4000 and the housing 1100.

That is, due to the arrangement of the first ball unit B1 and the second ball unit B2 diagonally spaced apart from each other, and the arrangement of the first sub-magnet 5110 and the second sub-magnet 5130 offset toward the first ball unit B1 and the second ball unit, a rotational force may be generated in the carrier 4000, and the first ball unit B1 and the second ball unit B2 may be held in contact with the carrier 4000 and the housing 1100 by the rotational force.

Although the rotational force is applied to the carrier 4000, the carrier 4000 is not rotated because the first ball unit B1 and the second ball unit B2 support the carrier 4000, and the carrier 4000 is supported to move in the optical axis (Z-axis) direction.

In the camera module 2 of FIG. 1, a center of the carrier 4000 may be disposed in a region in which a portion supported by the first ball unit B1 and a portion supported by the second ball unit B2 are connected to each other (that is, the center of the carrier 4000 is not spaced apart from the region in which the carrier 4000 is supported), the carrier 4000 may move parallel to the optical axis (Z-axis) direction without tilting. Accordingly, the driving stability during the autofocus operation may be improved.

When viewed in the optical axis (Z-axis) direction, the virtual line connecting the center of the first ball unit B1 and the center of the second ball unit B2 may form an acute angle with respect to a surface of the first sub-magnet 5110, and with respect to a surface of the second sub-magnet 5130.

When viewed in the optical axis (Z-axis) direction, the virtual line connecting the center of the first ball unit B1 and the center of the second ball unit B2 may form an acute angle with respect to the one side of the carrier 4000 on which the first sub-magnet 5110 is disposed, and with respect to the other side of the carrier 4000 on which the second sub-magnet 5130 is disposed.

When viewed in the optical axis (Z-axis) direction, the virtual line connecting the center of the first ball unit B1 and the center of the second ball unit B2 may pass through the lens module 2000. Specifically, the virtual line connecting the center of the first ball unit B1 and the center of the second ball unit B2 may pass through at least one lens accommodated in the lens module 2000.

The length of the virtual line connecting the center of the first ball unit B1 and the center of the second ball unit B2 may be greater than a maximum diameter of the lens barrel 2100.

When viewed in the optical axis (Z-axis) direction, the center of the carrier 4000 (or the center of the lens module 2000) may be disposed in a region in which a first region a1 defined by lines connecting opposite sides of the first ball unit B1 to opposite sides of the second ball unit B2 overlaps a second region a2 defined by lines connecting opposite ends of the first sub-magnet 5110 to opposite ends of the second sub-magnet 5130.

When viewed in the optical axis (Z-axis) direction, a center 8100a of the image sensor 8100 (or the center of an effective imaging surface of the image sensor 8100) may be disposed in the region in which the first region a1 connecting the opposite sides of the first ball unit B1 to the opposite sides of the second ball unit B2 overlaps the second region a2 connecting the opposite ends of the first sub-magnet 5110 to the opposite ends of the second sub-magnet 5130.

The camera module 2 may sense a position of the carrier 4000 in the optical axis (Z-axis) direction.

To this end, a first position sensor 5500 is provided. The first position sensor 5500 is mounted on the substrate 7000 facing the first magnet 5100. The first position sensor 5500 may be a Hall sensor.

The first position sensor 5500 may include two Hall sensors facing the first sub-magnet 5110 and the second sub-magnet 5130.

A stopper 2500 is coupled to the carrier 4000 to cover at least a portion of the upper surface of the lens module 2000. For example, the stopper 2500 may cover at least a portion of an upper surface of the lens holder 2300.

The stopper 2500 may prevent the guide frame 3000 and the lens module 2000 from being separated from the carrier 4000 due to an external impact or other disturbance.

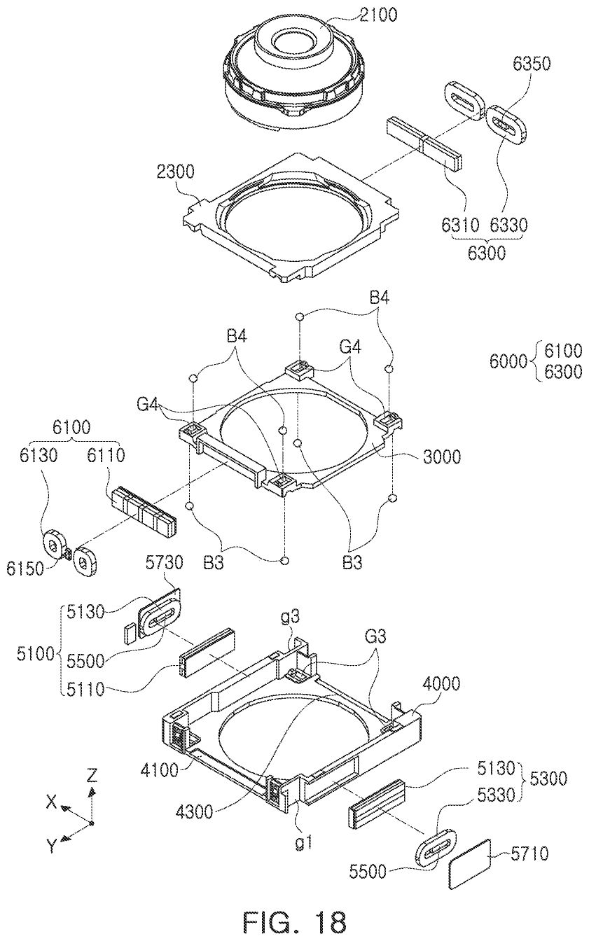

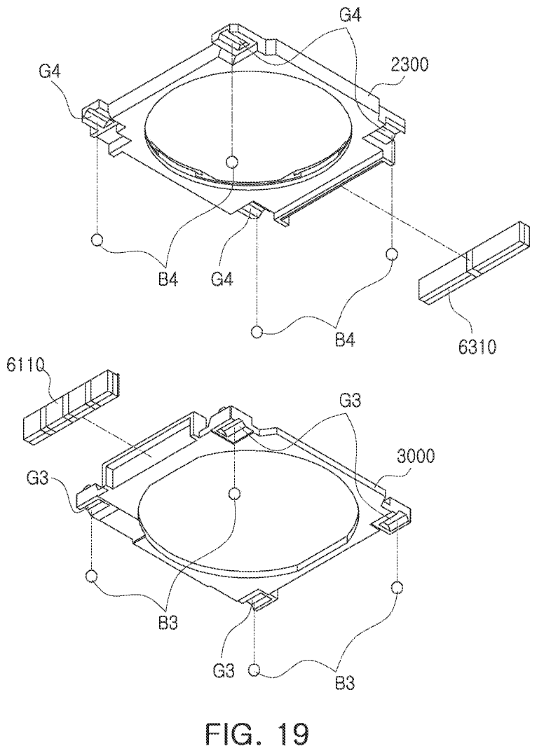

FIG. 18 is an exploded perspective view illustrating a partial configuration of a camera module according to another embodiment of the present disclosure, and FIG. 19 is a bottom perspective view of a lens holder and a guide frame of FIG. 18.

Referring to FIGS. 18 and 19, the camera module 2 may correct shaking during photographing by moving the lens module 2000 in a direction perpendicular to the optical axis (Z-axis) direction. To this end, the camera module 2 includes a second driver 6000 for moving the lens module 2000 in a direction perpendicular to the optical axis (Z-axis).

Referring to FIG. 18, a guide frame 3000 and a lens module 2000 may be sequentially disposed in the carrier 4000. For example, the guide frame 3000 may be disposed between the carrier 4000 and the lens module 2000. The guide frame 3000 may have a rectangular plate shape having a hole.

The guide frame 3000 and the lens module 2000 may be moved together in the first direction (X-axis direction) by the second driver 6000, and the lens module 2000 may be moved relative to the guide frame 3000 in the second direction (Y-axis direction) by the second driver 6000.

The second driver 6000 includes a first sub-driver 6100 and a second sub-driver 6300. The first sub-driver 6100 may generate a driving force in the first direction (X-axis direction), and the second sub-driver 6300 may generate a driving force in the second direction (Y-axis direction).

The first sub-driver 6100 includes a second magnet 6110 and a second coil 6130. The second magnet 6110 and the second coil 6130 may face each other in the second direction (Y-axis direction).

The second magnet 6110 may be disposed on the guide frame 3000. For example, the second magnet 6110 may be disposed on one side of the guide frame 3000.

One surface of the second magnet 6110 facing the second coil 6130 may be magnetized to have four poles. For example, the one surface of the second magnet 6110 may have a first N pole, a first neutral region, a first S pole, a second neutral region, a second N pole, a third neutral region, and a second S pole sequentially arranged in the first direction (X-axis direction).

The second coil 6130 faces the second magnet 6110. For example, the second coil 6130 may face the second magnet 6110 in the second direction (Y-axis direction).

The second coil 6130 may have a donut shape having a hole. The second coil 6130 may include a plurality of coils. For example, the second coil 6130 may include two coils spaced apart from each other in the first direction (X-axis direction), and each of coils may face the second magnet 6110.

In addition, the two coils may face the first and second N poles and the first and second S poles of the second magnet 6110. That is, one coil of the two coils may face the first N pole and the second S pole of the second magnet 6110, and the other coil of the two coils may face the second N pole and the second S pole of the second magnet 6110.

Accordingly, the second magnet 6110 and the second coil 6130 may generate the driving force in the first direction (X-axis direction) perpendicular to the second direction (Y-axis direction) in which the second magnet 6110 and the second coil 6130 face each other.

When correcting the shaking, the second magnet 6110 is a moving member mounted on the lens holder 2300, and the second coil 6130 is a fixed member fixed to the housing 1100.

When power is applied to the second coil 6130, the lens module 2000 and the guide frame 3000 may be moved in the first direction (X-axis direction) by an electromagnetic force generated between the second magnet 6110 and the second coil 6130.

The second sub-driver 6300 includes a third magnet 6310 and a third coil 6330. The third magnet 6310 and the third coil 6330 may face each other in the second direction (Y-axis direction).

The third magnet 6310 may be disposed on the lens module 2000. For example, the third magnet 6310 may be disposed on one side of the lens holder 2300.

One surface of the third magnet 6310 facing the third coil 6330 may be magnetized to have both an N pole and an S pole. For example, the one surface of the second magnet 6110 may have an N pole, a neutral region, and an S pole sequentially arranged in the first direction (X-axis direction).

The third coil 6330 faces the third magnet 6310. For example, the third coil 6330 may face the third magnet 6310 in the second direction (Y-axis direction).

The third coil 6330 may have a donut shape having a hole. The third coil 6330 may include a plurality of coils. For example, the third coil 6330 may include two coils spaced apart from each other in the first direction (X-axis direction), and each of the two coils may face the third magnet 6310.

In addition, the two coils may face different polarities of the one surface of the third magnet 6310. For example, one of the two coils may face the N pole of the third magnet 6310, and the other one of the two coils may face the S pole of the third magnet 6310.

Accordingly, the third magnet 6310 and the third coil 6330 may generate a driving force in the second direction (Y-axis direction) in which the third magnet 6310 and the third coil 6330 face each other.

The second coil 6130 and the third coil 6330 may be mounted on a substrate 7000 (not shown in FIGS. 18 and 19, but similar to the substrate 7000 shown in FIG. 12). For example, the second coil 6130 and the third coil 6330 may be mounted on the substrate 7000 facing the second magnet 6110 and the third magnet 6310 in the second direction (Y-axis direction).

The substrate 7000 is mounted on four sides of the housing 1100, and the second coil 6130 and the third coil 6330 may directly face the second magnet 6110 and the third magnet 6310 through openings in two sides of the housing 1100.

When correcting the shaking, the third magnet 6310 is a moving member mounted on the lens holder 2300, and the third coil 6330 is a fixed member fixed to the housing 1100.

When power is applied to the third coil 6330, the lens module 2000 may be moved in the second direction (Y-axis direction) by an electromagnetic force generated between the third magnet 6310 and the third coil 6330.

A virtual line extending from one surface of the second magnet 6110 in contact with the guide frame 3000 in a longitudinal direction of the second magnet 6110 may pass through the first ball unit B1 and may be spaced apart from the second ball unit B2. In addition, a virtual line extending from one surface of the third magnet 6310 in contact with the lens holder 2300 in a longitudinal direction of the third magnet 6310 may pass through the second ball unit B2 and may be spaced apart from the first ball unit B1.

The third ball unit B3 is disposed between the carrier 4000 and the guide frame 3000, and the fourth ball unit B4 is disposed between the guide frame 3000 and the lens module 2000.

The configurations of the third ball unit B3 and the fourth ball unit B4 are similar to the configurations of the third ball unit B3 and the fourth ball unit B4 of the camera module 1 of FIG. 1 described above with reference to FIGS. 1 to 10, and thus a detailed description thereof will be omitted.

A third set of guide grooves G3 that accommodates the third ball unit B3 is formed in at least one of the surfaces of the carrier 4000 and the guide frame 3000 facing each other in the optical axis (Z-axis) direction. The third set of guide grooves G3 includes a plurality of guide grooves corresponding to a plurality of balls of the third ball unit B3.

A fourth set of guide grooves G4 that accommodates the fourth ball unit B4 is formed in at least one of the surfaces of the guide frame 3000 and the lens module 2000 (e.g., the lens holder 2300) facing each other in the optical axis (Z-axis) direction. The fourth set of guide grooves G4 includes a plurality of guide grooves corresponding to a plurality of balls of the fourth ball unit B4.

The camera module 2 may sense a position of the lens module 2000 in a direction perpendicular to the optical axis (Z-axis) direction.

To this end, a second position sensor 6150 and a third position sensor 6350 are provided. The second position sensor 6150 may be mounted on the substrate 7000 facing the second magnet 6110, and the third position sensor 6350 may be mounted on the substrate 7000 facing the third magnet 6310. The second position sensor 6150 and the third position sensor 635 may be Hall sensors.

A second yoke 4100 and a third yoke 4300 are provided so that the carrier 4000 and the guide frame 3000 may remain in contact with the third ball unit B3, and the guide frame 3000 and the lens module 2000 may remain in contact with the fourth ball unit B4.

The second yoke 4100 and the third yoke 4300 are mounted on the carrier 4000 and face the second magnet 6110 and the third magnet 6310 in the optical axis (Z-axis) direction.

Accordingly, an attractive force is generated between the second yoke 4100 and the second magnet 6110 in the optical axis (Z-axis) direction, and an attractive force is generated between the third yoke 4300 and the third magnet 6310 in the optical axis (Z-axis) direction.

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing having an internal space;
a carrier disposed in the internal space of the housing;
a lens module disposed in the carrier;
a first driver comprising a first magnet coupled to the carrier, and a first coil facing the first magnet; and
a first ball unit and a second ball unit disposed between the carrier and the housing and spaced apart from each other in a direction perpendicular to an optical axis of the camera module,
wherein the first ball unit comprises two or more balls disposed in an optical axis direction, and the second ball unit comprises a smaller number of balls than the first ball unit disposed in the optical axis direction, and
a distance between the first ball unit and the second ball unit is greater than a length of a longest side of the carrier.

2. The camera module of claim 1, wherein when viewed in the optical axis direction, a virtual line connecting a center of a ball of the first ball unit and a center of a ball of the second ball unit passes through the lens module.

3. The camera module of claim 1, wherein when viewed in the optical axis direction, a virtual line connecting a center of a ball of the first ball unit and a center of a ball of the second ball unit forms an acute angle with respect to a line extending from one surface of the first magnet in a longitudinal direction of the first magnet.

4. The camera module of claim 1, wherein when viewed in the optical axis direction, a virtual line extending from one surface of the first magnet in contact with the carrier in a longitudinal direction of the first magnet passes through the first ball unit and is spaced apart from the second ball unit.

5. The camera module of claim 1, further comprising an image sensor module coupled to the housing and comprising an image sensor,
wherein when viewed in the optical axis direction, a center of the image sensor is disposed in a region defined by lines connecting opposite sides of the first ball unit to opposite side of the second ball unit.

6. The camera module of claim 1, wherein a first set of guide grooves and a second set of guide grooves are formed in the carrier and the housing,
the first set of guide grooves comprises a first guide groove formed in the carrier and a second guide groove formed in the housing, and the second set of guide grooves comprises a third guide groove formed in the carrier and a fourth guide groove formed in the housing,
the first ball unit is disposed between the first guide groove and the second guide groove,
the second ball unit is disposed between the third guide groove and the fourth guide groove, and
a direction in which a center of the first guide groove faces a center of the second guide groove is different from a direction in which a center of the third guide groove faces a center of the fourth guide groove.

7. The camera module of claim 6, wherein the first ball unit contacts the first guide groove at a first contact point and a second contact point, and contacts the second guide groove at a third contact point and a fourth contact point,
the first contact point and the third contact point face each other in a first direction perpendicular to the optical axis direction, and
the second contact point and the fourth contact point face each other in a second direction perpendicular to both the optical axis direction and the first direction.

8. The camera module of claim 1, wherein the first magnet is closer to the first ball unit than to the second ball unit.

9. The camera module of claim 1, further comprising:
a guide frame disposed between the lens module and the carrier;
a third ball unit disposed between the carrier and the guide frame; and
a fourth ball unit disposed between the lens module and the guide frame.

10. The camera module of claim 9, wherein a third set of guide grooves in which the third ball unit is disposed is formed in a lower surface of the guide frame facing the carrier in the optical axis direction,
a fourth set of guide grooves in which the fourth ball unit is disposed is formed in an upper surface of the guide frame facing the lens module in the optical axis direction, and
the third set of guide grooves and the fourth set of guide grooves do not overlap each other when viewed in the optical axis direction.

11. The camera module of claim 10, wherein the third set of guide grooves and the fourth set of guide grooves do not overlap each other in a first direction perpendicular to the optical axis direction,
some grooves of the third set of guide grooves and some grooves of the fourth set of guide grooves overlap each other in a second direction perpendicular to both the optical axis direction and the first direction, and
other grooves of the third set of guide grooves and other grooves of the fourth set of guide grooves do not overlap each other in the second direction.

12. The camera module of claim 1, further comprising:
a second driver comprising a second magnet coupled to the lens module, and a second coil facing the second magnet, and
a third driver comprising a third magnet coupled to the lens module, and a third coil facing the third magnet,
wherein each of the second magnet and the third magnet is closer to the second ball unit than to the first ball unit.

13. The camera module of claim 12, further comprising a substrate mounted on the housing and on which the first to third coils are mounted,
wherein the first ball unit is disposed at one corner of the housing, and the second ball unit is disposed at another corner of the housing diagonally opposite from the one corner of the housing, and
the substrate surrounds the other corner of the housing.

14. A camera module comprising:
a housing having an internal space;
a carrier disposed in the internal space of the housing;
a lens barrel disposed in the carrier;
a first driver comprising a first magnet coupled to the carrier, and a first coil facing the first magnet;
a first yoke fixed to the housing; and
a first ball unit and a second ball unit disposed between the carrier and the housing and spaced apart from each other in a direction perpendicular to an optical axis direction of the camera module,
wherein the first ball unit comprises two or more balls disposed in the optical axis direction, and the second ball unit comprises a smaller number of balls than the first ball unit disposed in the optical axis direction, and
when viewed in the optical axis direction, a length of a virtual line connecting a center of the first ball unit and a center of the second ball unit is greater than a maximum diameter of the lens barrel.

15. The camera module of claim 14, wherein the first magnet comprises a first sub-magnet disposed on one side of the carrier, and a second sub-magnet disposed on another side of the carrier on an opposite side of the carrier from the one side of the carrier,
the first coil comprises a first sub-coil facing the first sub-magnet, and a second sub-coil facing the second sub-magnet, and
the first yoke comprises a first sub-yoke facing the first sub-magnet, and a second sub-yoke facing the second sub-magnet.

16. The camera module of claim 15, wherein when viewed in the optical axis direction, a virtual line connecting a center of the first ball unit and a center of the second ball unit forms an acute angle with respect to the one side of the carrier on which the first sub-magnet is disposed, and with respect to the other side of the carrier on which the second sub-magnet is disposed.

17. The camera module of claim 15, wherein a center of the first sub-magnet is offset toward the first ball unit from the center of the one side of the carrier, and
a center of the second sub-magnet is offset toward the second ball unit from a center of the other side of the carrier.

18. The camera module of claim 17, further comprising an image sensor module coupled to the housing and comprising an image sensor,
wherein when viewed in the optical axis direction, a center of the image sensor is disposed in a region in which a first region defined by lines connecting opposite sides of the first ball unit to opposite sides of the second ball unit overlaps a second region defined by lines connecting opposite ends of the first sub-magnet to opposite ends of the second sub-magnet.

19. The camera module of claim 14, wherein the carrier comprises a first guide groove and a third guide groove, and the housing comprises a second guide groove and a fourth guide groove,
the first ball unit is disposed between the first guide groove and the second guide groove,
the second ball unit is disposed between the third guide groove and the fourth guide groove,
the first ball unit contacts the first guide groove at a first contact point and a second contact point,
the first ball unit contacts the second guide groove at a third contact point and a fourth contact point,
the first contact point and the third contact point face each other in a first direction perpendicular to the optical axis direction, and
the second contact point and the fourth contact point face each other in a second direction perpendicular to both the optical axis direction and the first direction.

20. A camera module comprising:
a housing having an internal space and four corners when viewed in an optical axis direction of the housing;
a carrier disposed in the internal space of the housing;
a lens module disposed in the carrier;
a first driver configured to move the carrier and the lens module together in the optical axis direction;
a first ball unit extending in the optical axis direction and disposed between the carrier and the housing at a first corner of the housing; and
a second ball unit extending in the optical axis direction and disposed between the carrier and the housing at a second corner of the housing diagonally opposite from the first corner of the housing,
wherein the first ball unit and the second ball unit are the only ball units disposed between the carrier and the housing, and support the carrier in the housing to enable the carrier and the lens module to be moved together in the optical axis direction by the first driver.

21. The camera module of claim 20, wherein the first ball unit comprises two or more balls disposed in the optical axis direction, and the second ball unit comprises a smaller number of balls than the first ball unit disposed in the optical axis direction.

22. The camera module of claim 20, wherein the first driver comprises a first magnet disposed on one side of the carrier, and a first coil fixed to the housing and facing the first magnet in a first direction perpendicular to the optical axis direction,
the camera module further comprises a first yoke fixed to the housing and facing the first magnet in the first direction with the first coil being disposed between the first yoke and the first magnet, and
an attractive force generated between the first magnet and the first yoke in the first direction applies a rotational force to the carrier in a plane perpendicular to the optical axis direction.

23. The camera module of claim 22, wherein a center of the first magnet is offset in a second direction perpendicular to both the optical axis direction and the first direction from a center of the one side of the carrier on which the first magnet is disposed.

24. A camera module comprising:
a housing having an internal space;
a carrier disposed in the internal space of the housing;
a lens module disposed in the carrier;
a first driver configured to move the carrier and the lens module together in an optical axis direction of the camera module while applying a rotational force to the carrier in a plane perpendicular to the optical axis;
a first ball unit extending in the optical axis direction and disposed between the carrier and the housing; and
a second ball unit extending in the optical axis direction and disposed between the carrier and the housing,
wherein the first ball unit and the second ball unit support the carrier in the housing to enable the carrier and the lens module to be moved together in the optical axis direction by the first driver.

25. The camera module of claim 24, wherein the driver comprises:
a first sub-magnet disposed on one side of the carrier;
a first sub-coil fixed to the housing and facing the first sub-magnet in a first direction perpendicular to the optical axis direction;
a second sub-magnet disposed on another side of the carrier on an opposite side of the carrier from the one side of the carrier in the first direction; and
a second sub-coil fixed to the housing and facing the second sub-magnet in the first direction,
the one side of the carrier on which the first sub-magnet is disposed and the other side of the carrier on which the second sub-magnet is disposed extend in a second direction perpendicular to both the optical axis direction and the first direction, and
when viewed in the optical axis direction, a virtual line extending through a center of the first sub-magnet in the first direction is spaced apart in the second direction from a virtual line extending through a center of the second sub-magnet.

26. The camera module of claim 25, wherein the housing has four corners when viewed in the optical axis direction,
the first ball unit is disposed at a first corner of the housing, and
the second ball unit disposed at a second corner of the housing diagonally opposite from the first corner of the housing.

27. The camera module of claim 26, wherein a first end of the first sub-magnet in the second direction is disposed adjacent to the first ball unit, and a second end of the first sub-magnet in the second direction is spaced apart from a third corner of the housing in the second direction,
a first end of the second sub-magnet in the second direction is disposed adjacent to the second ball unit, and a second end of the second sub-magnet in the second direction is spaced apart from a fourth corner of the housing in the second direction, and
the fourth corner of the housing is diagonally opposite from the third corner of the housing.
